(19) United States
(12) Patent Application Publication
(10) Pub. No.: US 2021/0007156 A1
(43) Pub. Date: Jan. 7, 2021

(54) TRANSPORT LAYER CONNECTIONS FOR MOBILE COMMUNICATION NETWORKS

(71) Applicant: Intel Corporation, Santa Clara, CA (US)

(72) Inventor: Yifan YU, Beijing (CN)

(21) Appl. No.: 16/975,883

(22) PCT Filed: Jun. 29, 2018
(86) PCT No.: PCT/CN2018/093786

§ 371 Date: Aug. 26, 2020

(51) Int. Cl. H04W 76/10; H04L 29/08

(52) U.S. Cl. CPC H04W 76/10; H04W 80/06; H04L 67/2842

(57) ABSTRACT

Embodiments include apparatuses, methods, and systems that may be used in a UE or a base station in a mobile communication network. A processing circuitry may receive, from the UE, a request for a network connection to a content server, where the request for the network connection may include a request for a transport layer connection between the UE and the content server. The processing circuitry may establish a transport layer connection between the base station and the content server based on the request for the transport layer connection between the UE and the content server. The processing circuitry may further fetch at least a portion of data from the content server and store the portion of the data in a storage device before a physical channel between the base station and the UE is available. Other embodiments may also be described and claimed.

### TECHNICAL FIELD

Embodiments generally may relate to the field of mobile communication network, wireless communications, and wired communications.

### BACKGROUND

Wireless communications may be a type of communication performed and delivered wirelessly by a mobile communication network or a wireless system. Wireless communication may be a broad term that incorporates all procedures and forms of connecting and communicating between two or more devices using a wireless signal through a non-solid medium using wireless communication technologies and devices in addition to other communication technologies and devices. Wired communication may refer to the transmission of data or information over a wire-based communication technology. Wire-based communication technology may include telephone networks, internet access, fiber-optic communication, and more.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example and not by way of limitation in the figures of the accompanying drawings.

FIG. 1 illustrates a schematic high-level example of a mobile communication network that includes multiple user equipments (UEs), and a base station, where the base station may establish a transport layer connection between the base station and a content server based on a request for a transport layer connection between a UE and the content server, in accordance with various embodiments.

FIG. 2 illustrates an example process for a UE, a base station, and a content server, to transmit a portion of data to the UE when a physical channel is available between the base station and the UE, the data fetched from the content server based on a request for a network connection and stored in a storage device of the base station, in accordance with various embodiments.

FIG. 3 illustrates an example diagram for a base station to transmit a portion of data to a UE when a physical channel is available between the base station and the UE, in accordance with various embodiments.

FIG. 4 illustrates an example diagram of a frame structure for a transmission time interval (TTI) for a base station to transmit a portion of data to a UE, in accordance with various embodiments.

FIG. 5 illustrates an example process for a UE, a mmWave base station, and a content server, in a millimeter-wave (mmWave) cellular network to establish a transport layer connection between the mmWave base station and the content server based on a request for a transport layer connection between the UE and the content server, in accordance with various embodiments.

FIG. 6 illustrates a performance evaluation, in accordance with various embodiments.

FIG. 7 illustrates a performance evaluation, in accordance with various embodiments.

FIG. 8 illustrates an example architecture of a mobile communication network that includes multiple UEs, and one or more base stations, in accordance with various embodiments.

FIG. 9 illustrates a block diagram of an implementation for a base station and/or UEs, in accordance with various embodiments.

FIG. 10 illustrates interfaces of baseband circuitry as a part of an implementation for base stations and/or UEs, in accordance with various embodiments.

FIG. 11 illustrates an example control plane protocol stack, in accordance with various embodiments.

FIG. 12 illustrates an example user plane protocol stack, in accordance with various embodiments.

FIG. 13 illustrates a block diagram illustrating components able to read instructions from a machine-readable or computer-readable medium and perform any one or more of the methodologies discussed herein, in accordance with various embodiments.

### DETAILED DESCRIPTION

Communication technologies may include various wireless communications performed by a mobile communication network or a wireless system, or wired communication. A cellular network or mobile network may be a communication network where the last link is wireless. A cellular network may be distributed over land areas called cells, each served by one or more fixed-location transmission/reception points (TRPs) or base stations. These base stations may provide to one or more user equipments (UEs) within the cell network coverage that can be used for transmission of voice, data and other services. A millimeter-wave (mmWave) system may be an example of a cellular system offering high-speed radio coverage in hotspots in a large spectrum bandwidth. However, existing transport layer protocols, e.g., transmission control protocol (TCP) protocol, may not be able to fully utilize the high data rate provided by a mmWave system due to the poor utilization of radio channel caused by mismatched interactions between a mmWave base station and a content server.

Embodiments herein include functions for a base station, which are performed by a processing circuitry within the base station, to improve the performance of transport layer connections in a mobile communication network e.g., a cellular system. For example, the processing circuitry may be a performance enhancement proxy (PEP) in a mmWave base station. Instead of establishing a transport layer connection between a UE and a content server to fetch data from the content server to the UE, embodiments herein establish a transport layer connection between the UE and the base station and a transport layer connection between the base station and the content server. The transport layer connection between the base station and the content server may be established by the base station once a request for a network connection to the content server is received by the base station. The base station may further fetch at least a portion of the data from the content server and store the portion of the data in a storage device of the base station before a physical channel between the base station and the UE is available. In addition, embodiments herein utilize a frame structure to transmit the portion of the data to the UE, where the frame structure may allow multiple downlink (DL)/uplink (UL) operations in a single transmission time interval (TTI) so that the time consumption for the transport layer connection establishment may be reduced. Embodiments herein may be implemented on a base station without significant modification of functions on a UE. In addition, embodiments herein may improve the performance for establishing a transport layer connection between a UE and a content server to fetch data from the content server to the UE. Even though the embodiments described herein are presented in the context of a cellular system as examples, the embodiments may be applicable to any transport layer connections for a mobile communication network, such as wireless LAN.

In embodiments, an apparatus used in a base station in a mobile communication network communicates with a UE. The apparatus includes a storage device and processing circuitry coupled with the storage device. The storage device stores data received from a content server. The apparatus may be coupled with radio communication circuitry used to communicate with the UE using wireless signaling, and may be coupled with network interface circuitry used to communicate with a content server. The processing circuitry may receive, from the UE, a request for a network connection to the content server, where the request for the network connection includes a request for a transport layer connection between the UE and the content server. The processing circuitry may establish a transport layer connection between the base station and the content server based on the request for the transport layer connection between the UE and the content server. The processing circuitry may further fetch at least a portion of the data from the content server and store the portion of the data in the storage device before a physical channel between the base station and the UE is available. In addition, the processing circuitry may transmit the portion of the data stored in the storage device to the UE when the physical channel is available between the base station and the UE.

In embodiments, an apparatus may be used in a UE in a mobile communication network to communicate with a base station. The apparatus may include a storage device and processing circuitry coupled with the storage device. The storage device may be used to store data received from a content server. The processing circuitry may transmit, to the base station, a request for a network connection to the content server, where the request for the network connection may include a request for a transport layer connection between the UE and the content server. The processing circuitry may further establish a transport layer connection between the UE and the base station based on the request for the transport layer connection between the UE and the content server. In addition, the processing circuitry may receive an assignment of a physical channel between the UE and the base station. Moreover, the processing circuitry may receive at least a portion of the data from the content server transmitted over the physical channel. The portion of the data may be fetched by the base station from the content server after the base station receives the request for the network connection to the content server and before receiving the assignment of the physical channel, and stored in the base station after being fetched.

In embodiments, an apparatus may be used in a mmWave base station in a mmWave cellular network to communicate with a UE. The apparatus may include a storage device to store data received from a content server, and processing circuitry coupled with the storage device. The processing circuitry may receive, from the UE, a request for a network connection to the content server, where the request for the network connection may include a request for a transport layer connection between the UE and the content server. The processing circuitry may establish a first TCP connection between the UE and the mmWave base station based on the request for the transport layer connection between the UE and the content server, and establish a second TCP connection between the mmWave base station and the content server based on the request for the transport layer connection. The first TCP connection and the second TCP connection may substitute the transport layer connection between the UE and the content server. Furthermore, the processing circuitry may fetch at least a portion of the data from the content server and store the portion of the data in the storage device before a physical channel between the mmWave base station and the UE is available. In embodiments, the portion of the data may be fetched as TCP packets. Moreover, the processing circuitry may transmit the portion of the data stored in the storage device to the UE when the physical channel is available between the mmWave base station and the UE.

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail.

Operations of various methods may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiments. Various additional operations may be performed and/or described operations may be omitted, split or combined in additional embodiments.

For the purposes of the present disclosure, the phrases “A/B,” “A or B,” and “A and/or B” mean (A), (B), or (A and B). For the purposes of the present disclosure, the phrases “A, B, or C” and “A, B, and/or C” mean (A), (B), (C), (A and B), (A and C), (B and C), or (A, B and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

As discussed herein, the term “module” may be used to refer to one or more physical or logical components or elements of a system. In some embodiments, a module may be a distinct circuit, while in other embodiments a module may include a plurality of circuits.

Where the disclosure recites “a” or “a first” element or the equivalent thereof, such disclosure includes one or more such elements, neither requiring nor excluding two or more such elements. Further, ordinal indicators (e.g., first, second or third) for identified elements are used to distinguish between the elements, and do not indicate or imply a required or limited number of such elements, nor do they indicate a particular position or order of such elements unless otherwise specifically stated.

The terms “coupled with” and “coupled to” and the like may be used herein. “Coupled” may mean one or more of the following. “Coupled” may mean that two or more elements are in direct physical or electrical contact. However, “coupled” may also mean that two or more elements indirectly contact each other, but yet still cooperate or interact with each other, and may mean that one or more other elements are coupled or connected between the elements that are said to be coupled with each other. By way of example and not limitation, “coupled” may mean two or more elements or devices are coupled by electrical connections on a printed circuit board such as a motherboard, for example. By way of example and not limitation, “coupled” may mean two or more elements/devices cooperate and/or interact through one or more network linkages such as wired and/or wireless networks. By way of example and not limitation, a computing apparatus may include two or more computing devices “coupled” on a motherboard or by one or more network linkages.

As used herein, the term “circuitry” refers to, is part of, or includes hardware components such as an electronic circuit, a logic circuit, a processor (shared, dedicated, or group) and/or memory (shared, dedicated, or group), an Application Specific Integrated Circuit (ASIC), a field-programmable device (FPD), (for example, a field-programmable gate array (FPGA), a programmable logic device (PLD), a complex PLD (CPLD), a high-capacity PLD (HCPLD), a structured ASIC, or a programmable System on Chip (SoC)), digital signal processors (DSPs), etc., that are configured to provide the described functionality. In some embodiments, the circuitry may execute one or more software or firmware programs to provide at least some of the described functionality.

As used herein, the term “processor circuitry” may refer to, is part of, or includes circuitry capable of sequentially and automatically carrying out a sequence of arithmetic or logical operations; recording, storing, and/or transferring digital data. The term “processor circuitry” may refer to one or more application processors, one or more baseband processors, a physical central processing unit (CPU), a single-core processor, a dual-core processor, a triple-core processor, a quad-core processor, and/or any other device capable of executing or otherwise operating computer-executable instructions, such as program code, software modules, and/or functional processes.

As used herein, the term “interface circuitry” may refer to, is part of, or includes circuitry providing for the exchange of information between two or more components or devices. The term “interface circuitry” may refer to one or more hardware interfaces (for example, buses, input/output (I/O) interfaces, peripheral component interfaces, network interface cards, and/or the like).

As used herein, the term “computer device” may describe any physical hardware device capable of sequentially and automatically carrying out a sequence of arithmetic or logical operations, equipped to record/store data on a machine readable medium, and transmit and receive data from one or more other devices in a communications network. A computer device may be considered synonymous to, and may hereafter be occasionally referred to, as a computer, computing platform, computing device, etc. The term “computer system” may include any type interconnected electronic devices, computer devices, or components thereof. Additionally, the term “computer system” and/or “system” may refer to various components of a computer that are communicatively coupled with one another. Furthermore, the term “computer system” and/or “system” may refer to multiple computer devices and/or multiple computing systems that are communicatively coupled with one another and configured to share computing and/or networking resources. Examples of “computer devices”, “computer systems”, etc. may include cellular phones or smart phones, feature phones, tablet personal computers, wearable computing devices, an autonomous sensors, laptop computers, desktop personal computers, video game consoles, digital media players, handheld messaging devices, personal data assistants, an electronic book readers, augmented reality devices, server computer devices (e.g., stand-alone, rack-mounted, blade, etc.), cloud computing services/systems, network elements, in-vehicle infotainment (IVI), in-car entertainment (ICE) devices, an Instrument Cluster (IC), head-up display (HUD) devices, onboard diagnostic (OBD) devices, dashtop mobile equipment (DME), mobile data terminals (MDTs), Electronic Engine Management Systems (EEMSs), electronic/engine control units (ECUs), vehicle-embedded computer devices (VECDs), autonomous or semi-autonomous driving vehicle (hereinafter, simply ADV) systems, in-vehicle navigation systems, electronic/engine control modules (ECMs), embedded systems, microcontrollers, control modules, engine management systems (EMS), networked or “smart” appliances, machine-type communications (MTC) devices, machine-to-machine (M2M), Internet of Things (IoT) devices, and/or any other like electronic devices. Moreover, the term “vehicle-embedded computer device” may refer to any computer device and/or computer system physically mounted on, built in, or otherwise embedded in a vehicle.

As used herein, the term “network element” may be considered synonymous to and/or referred to as a networked computer, networking hardware, network equipment, router, switch, hub, bridge, radio network controller, radio access network device, gateway, server, and/or any other like device. The term “network element” may describe a physical computing device of a wired or wireless communication network and be configured to host a virtual machine. Furthermore, the term “network element” may describe equipment that provides radio baseband functions for data and/or voice connectivity between a network and one or more users. The term “network element” may be considered synonymous to and/or referred to as a “base station.” As used herein, the term “base station” may be considered synonymous to and/or referred to as a node B, an enhanced or eNB, gNB, base transceiver station (BTS), access point (AP), roadside unit (RSU), etc., and may describe equipment that provides the radio baseband functions for data and/or voice connectivity between a network and one or more users. As used herein, the terms “vehicle-to-vehicle” and “V2V” may refer to any communication involving a vehicle as a source or destination of a message.

Additionally, the terms “vehicle-to-vehicle” and “V2V” as used herein may also encompass or be equivalent to vehicle-to-infrastructure (V2I) communications, vehicle-to-network (V2N) communications, vehicle-to-pedestrian (V2P) communications, or V2X communications

As used herein, the term “channel” may refer to any transmission medium, either tangible or intangible, which is used to communicate data or a data stream. The term “channel” may be synonymous with and/or equivalent to “physical channel,” “communications channel,” “data communications channel,” “transmission channel,” “data transmission channel,” “access channel,” “data access channel,” “link,” “data link,” “carrier,” “radiofrequency carrier,” and/or any other like term denoting a pathway or medium through which data is communicated. Additionally, the term “link” may refer to a connection between two devices through a Radio Access Technology (RAT) for the purpose of transmitting and receiving information.

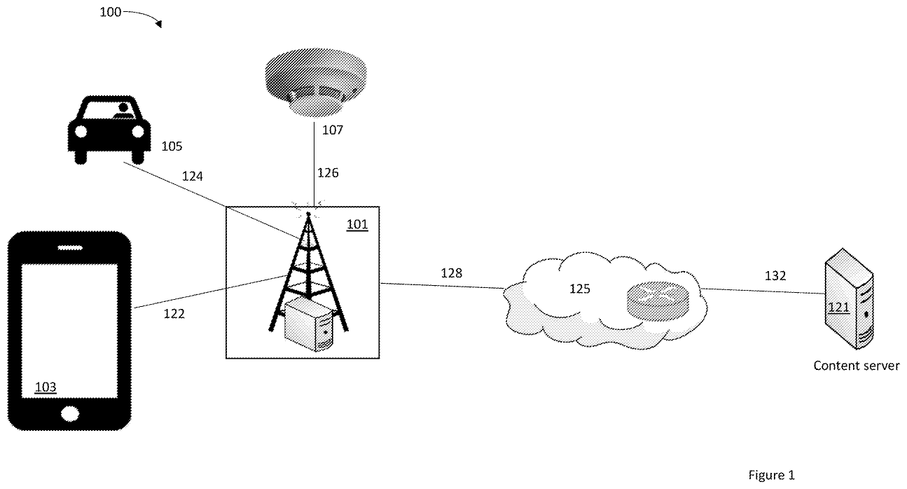

FIG. 1 illustrates a schematic high-level example of a mobile communication network 100 that includes multiple user equipments (UEs), e.g., a UE 103 that may be a smartphone, a UE 105 that may be an onboard vehicle system, a UE 107 that may be a sensor, and a base station 101, where the base station 101 may establish a transport layer connection between the base station 101 and a content server 121 based on a request for a transport layer connection between a UE, e.g., the UE 103, and the content server 121, in accordance with various embodiments. For clarity, features of a UE, a base station, a content server, e.g., the UE 103, the UE 105, the UE 107, the base station 101, and the content server 121, may be described below as examples for understanding an example UE, a base station, or a content server. It is to be understood that there may be more or fewer components within a UE, a base station, or a content server. Further, it is to be understood that one or more of the components within a UE, a base station, or a content server, may include additional and/or varying features from the description below, and may include any device that one having ordinary skill in the art would consider and/or refer to as a UE, a base station, or a content server.

In embodiments, the mobile communication network 100 may be a mmWave cellular network, or any other wireless network. The mobile communication network 100 includes multiple UEs, e.g., the UE 103, the UE 105, the UE 107, and the base station 101 operating over a physical resource of a medium, e.g., a medium 122, a medium 124, a medium 126, a medium 128, or other medium. A medium, e.g., the medium 122, may be referred as a channel or a physical channel including a downlink and an uplink. Communications are performed over a medium according to various layers of one or more protocols, e.g., an application layer, a transport layer, a network layer, a layer 2 protocol stack, a physical layer, or more. The layer 2 protocol stack may be subdivided in to multiple different entities or layers depending on the protocol used. In embodiments, a UE, e.g., the UE 103, may be an IoT UE, a MTC UE, a M2M UE, or any other UEs. The base station 101 may be a mnWave base station, or any other base station for any wireless system. The base station 101 is coupled to a core network 125 through the medium 128, and the core network 125 may be coupled to the content server 121 through a medium 132, which may be a wired connection. The base station 101 may be further coupled to the content server 121 through the core network 125. In some embodiments, the core network 125 may be coupled to the base station 101 through a wireless communication router, not shown.

In embodiments, the UE 103 may transmit to the base station 101 a request for a network connection to the content server 121. The request for a network connection to the content server 121 may include various information, such as an internet protocol (IP) address, which may be a unique string of numbers separated by periods that identifies the content server 121 using the Internet Protocol. Additionally or alternatively, the request for a network connection to the content server 121 may include a request for a transport layer connection between the UE 103 and the content server 121. Upon receiving the request for a transport layer connection between the UE 103 and the content server 121, instead of having a transport layer connection between the UE 103 and the content server 121 based on the request, the base station 101 establishes a first transport layer connection between the UE 103 and the base station 101, and a second transport layer connection between the base station 101 and the content server 121. The two separated transport layer connections between the base station 101, the content server 121, and the UE 103 may provide additional flexibility for data transmission. For example, the second transport layer connection between the base station 101 and the content server 121 may be established before the first transport layer connection between the UE 103 and the base station 101 is established. The base station 101 may fetch at least a portion of the data from the content server 121 and store the portion of the data in a storage device of the base station 101 before a physical channel between the base station 101 and the UE 103 is made available. Hence, a portion of the data from the content server 121 may be pre-fetched before a physical channel is available, and may be transmitted to the UE 103 when the physical channel is available between the base station 101 and the UE 103. The pre-fetched portion of data from the content server 121 may provide improved performance of the transport layer connection as compared to a single transport layer connection between the UE 103 and the content server 121.

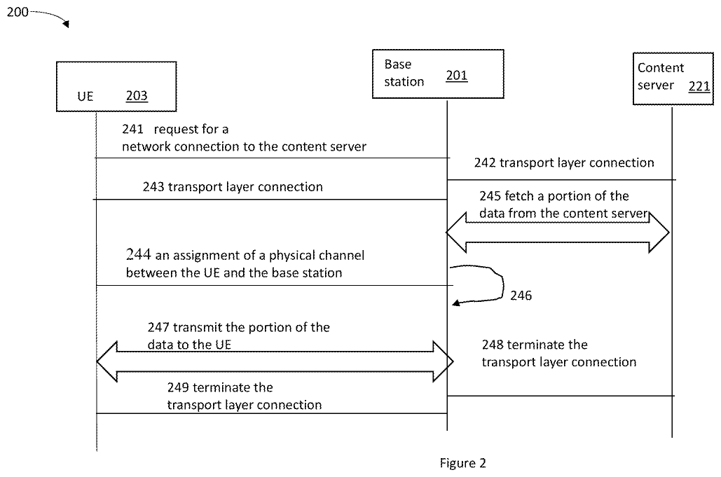

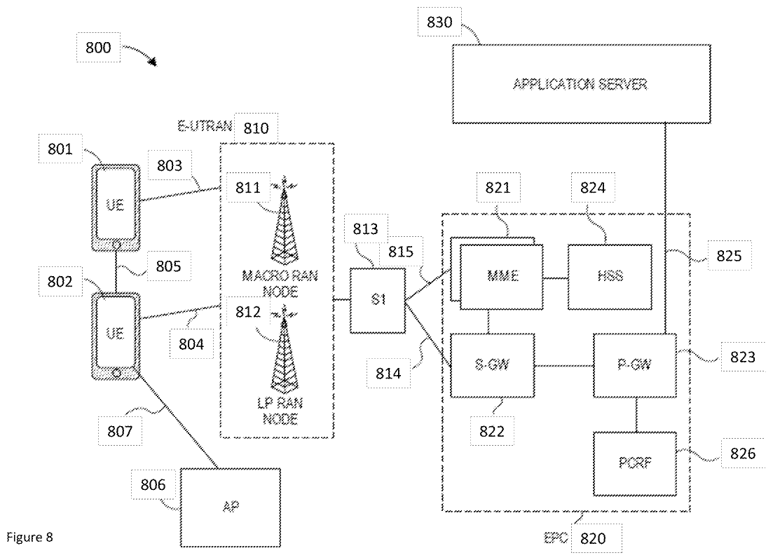

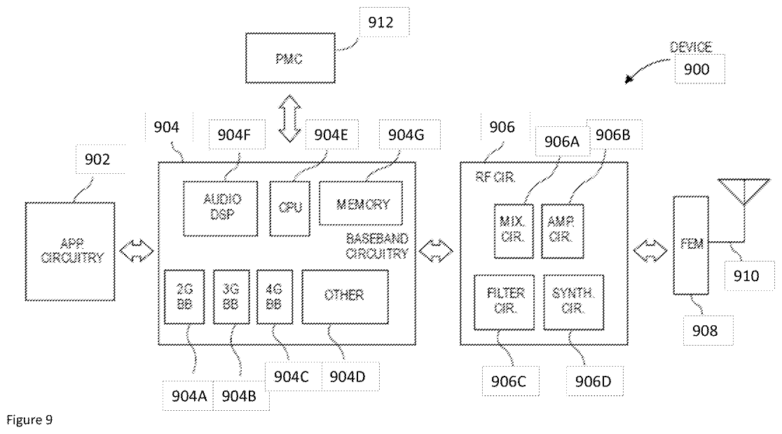

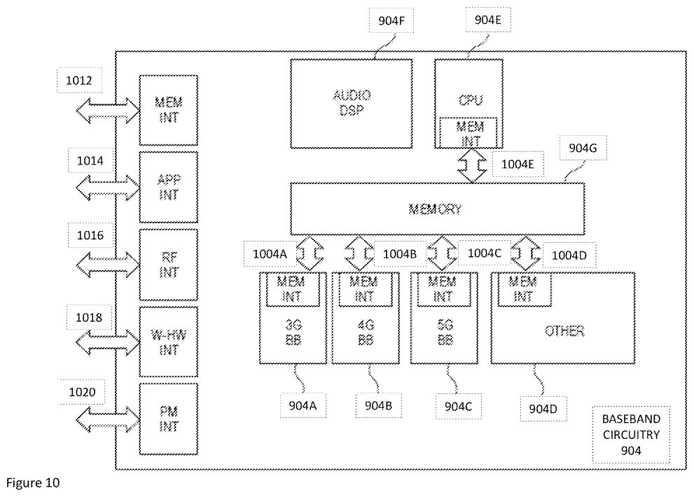

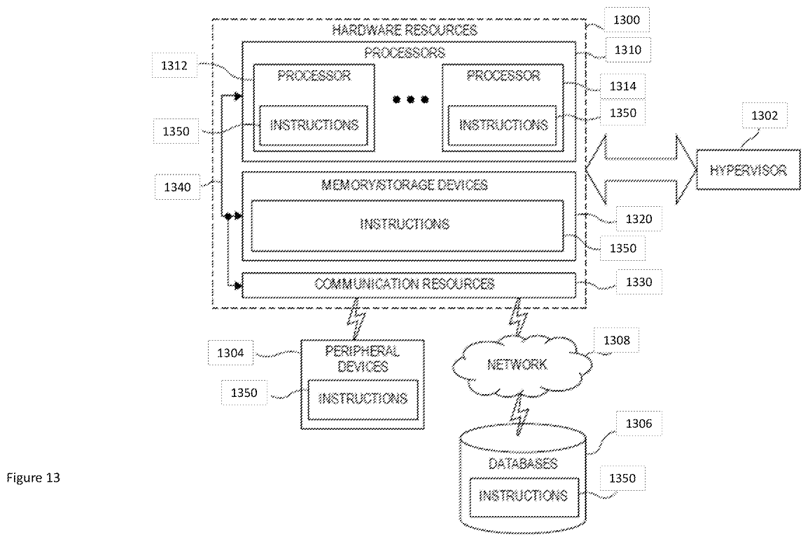

In embodiments, the base station 101 may be implemented by devices including one or more processors, as shown in FIG. 8, FIG. 9, FIG. 10, or FIG. 13, to perform various operations, e.g., operations outlined in FIGS. 2-5. A computer-readable medium may include instructions to cause the base station 101, upon execution of the instructions by one or more processors, to perform various operations, e.g., operations outlined in FIGS. 2-5.

In embodiments, the UE 103 may be implemented by devices including one or more processors, as shown in FIG. 8, FIG. 9, FIG. 10, or FIG. 13, to perform various operations, e.g., operations outlined in FIGS. 2-5. A computer-readable medium may include instructions to cause the UE 103, upon execution of the instructions by one or more processors, to perform various operations, e.g., operations outlined in FIGS. 2-5.

In embodiments, the content server 121 may be implemented by devices including one or more processors, as shown in FIG. 8, FIG. 9, FIG. 10, or FIG. 13, to perform various operations, e.g., operations outlined in FIGS. 2-5. For example, the content server is distributed across multiple devices coupled together, wherein the multiple devices include one or more storage devices, one or more processors, or one or more network devices. A computer-readable medium may include instructions to cause the content server 121, upon execution of the instructions by one or more processors, to perform various operations, e.g., operations outlined in FIGS. 2-5.

In some embodiments, the medium 122 may be a narrowband channel with a bandwidth of 180 kHz or 200 kHz. In some other embodiments, the medium 122 may be a band in any frequency range (in particular 0 Hz-300 GHz), such as for example unlicensed bands (as the 5 GHz ISM band) or the licensed-by-rule approach which is applied by the FCC (Federal Communications Commission) to the 3.5 GHz Spectrum Access System (SAS) General Authorized Access (GAA) tier, etc. Some targets for future application may include the 28, 37 and 60 GHz bands. In particular, techniques that have been designed for unlicensed bands may be used straightforwardly (only adapting the channel access parameters as described in this document) but also various other systems can be used following a suitable adaptation (see for example the modification of 3GPP LTE to introduce LAA in the 5 GHz ISM band).

In embodiments, the mobile communication network 100 may include in particular the following: LTE and Long Term Evolution-Advanced (LTE-A) and LTE-Advanced Pro, 5th Generation (5G) communication systems, a NB-IoT network, a LPWAN, a MTC, an eMTC, a MIoT, an EC-GSM-IoT, a Global System for Mobile Communications (GSM) radio communication technology, a General Packet Radio Service (GPRS) radio communication technology, an Enhanced Data Rates for GSM Evolution (EDGE) radio communication technology, and/or a Third Generation Partnership Project (3GPP) radio communication technology (e.g. UMTS (Universal Mobile Telecommunications System), FOMA (Freedom of Multimedia Access), 3GPP LTE, 3GPP LTE Advanced (Long Term Evolution Advanced)), 3GPP LTE-Advanced Pro, CDMA2000 (Code division multiple access 2000), CDPD (Cellular Digital Packet Data), Mobitex, 3G (Third Generation), CSD (Circuit Switched Data), HSCSD (High-Speed Circuit-Switched Data), UITS (3G) (Universal Mobile Telecommunications System (Third Generation)), W-CDMA (UMTS) (Wideband Code Division Multiple Access (Universal Mobile Telecommunications System)), HSPA (High Speed Packet Access), HSDPA (High-Speed Downlink Packet Access), HSUPA (High-Speed Uplink Packet Access), HSPA+(High Speed Packet Access Plus), UMTS-TDD (Universal Mobile Telecommunications System—Time-Division Duplex), TD-CDMA (Time Division—Code Division Multiple Access), TD-CDMA (Time Division—Synchronous Code Division Multiple Access), 3GPP Rel. 8 (Pre-4G) (3rd Generation Partnership Project Release 8 (Pre-4th Generation)), 3GPP Rel. 9 (3rd Generation Partnership Project Release 9), 3GPP Rel. 10 (3rd Generation Partnership Project Release 10), 3GPP Rel. 11 (3rd Generation Partnership Project Release 11), 3GPP Rel. 12 (3rd Generation Partnership Project Release 12), 3GPP Rel. 13 (3rd Generation Partnership Project Release 14), 3GPP Rel. 14 (3rd Generation Partnership Project Release 14), 3GPP Rel. 15 (3rd Generation Partnership Project Release 15), 3GPP Rel. 16 (3rd Generation Partnership Project Release 16), 3GPP Rel. 17 (3rd Generation Partnership Project Release 17), 3GPP LTE Extra, LTE Licensed-Assisted Access (LAA), UTRA (UITS Terrestrial Radio Access), E-UTRA (Evolved UMTS Terrestrial Radio Access), LTE Advanced (4G) (Long Term Evolution Advanced (4th Generation)), ETSI OneM2M, IoT (Internet of things), cdmaOne (2G), CDMA2000 (3G) (Code division multiple access 2000 (Third generation)), EV-DO (Evolution-Data Optimized or Evolution-Data Only), AMPS (1G) (Advanced Mobile Phone System (1st Generation)). TACS/ETACS (Total Access Communication System/Extended Total Access Communication System), D-AMPS (2G) (Digital AMPS (2nd Generation)), PTT (Push-to-talk), MTS (Mobile Telephone System), IMTS (Improved Mobile Telephone System), AMTS (Advanced Mobile Telephone System), OLT (Norwegian for Offentlig Landmobil Telefoni, Public Land Mobile Telephony), MTD (Swedish abbreviation for Mobiltelefonisystem D, or Mobile telephony system D), Autotel/PALM (Public Automated Land Mobile), ARP (Finnish for “Autoradiopuhelin car radio phone”), NMT (Nordic Mobile Telephony), Hicap (High capacity version of NTT (Nippon Telegraph and Telephone)), CDPD (Cellular Digital Packet Data), Mobitex, DataTAC, iDEN (Integrated Digital Enhanced Network), PDC (Personal Digital Cellular), CSD (Circuit Switched Data), PHS (Personal Handy-phone System), WiDEN (Wideband Integrated Digital Enhanced Network), iBurst, Unlicensed Mobile Access (UMA, also referred to as also referred to as 3GPP Generic Access Network, or GAN standard)), Wireless Gigabit Alliance (WiGig) standard, mmWave standards in general (wireless systems operating at 10-90 GHz and above such as WiGig, IEEE 802.11ad, IEEE 802.11ay, etc.), etc. It is understood that such exemplary scenarios are demonstrative in nature, and accordingly may be similarly applied to other mobile communication technologies and standards.

FIG. 2 illustrates an example process 200 for a UE 203, a base station 201, and a content server 221, to transmit a portion of data to the UE 201 when a physical channel is available between the base station 201 and the UE 203, the data fetched from the content server 221 based on a request for a network connection and stored in a storage device of the base station 201, in accordance with various embodiments. In embodiments, the UE 203, the base station 201, and the content server 221 may be examples of the UE 103, the base station 101, and the content server 121 as shown in FIG. 1. In embodiments, the base station 201 may include a storage device to store data received from the content server 221, and processing circuitry to perform operations illustrated in the process 200. Similarly, the UE 203 may include a storage device to store data received from the content server 221, and processing circuitry to perform operations illustrated in the process 200.

In embodiments, the process 200 may start at an interaction 241. During the interaction 241, the UE 203 may transmit to the base station 201, a request for a network connection to the content server 221, where the request for the network connection may include a request for a transport layer connection between the UE 203 and the content server 221. Accordingly, the base station 201 may receive from the UE 203 the request for the network connection to the content server 221.

During an interaction 242, the base station 201 may establish a transport layer connection between the base station 201 and the content server 221 based on the request for the transport layer connection between the UE 203 and the content server 221. During an interaction 243, the base station 201 may establish a transport layer connection between the UE 203 and the base station 201. The transport layer connection between the UE 203 and the base station 201 and the transport layer connection between the base station 201 and the content server 221 may substitute a transport layer connection between the UE 203 and the content server 221. In embodiments, the transport layer connection between the base station 201 and the content server 221 may be a TCP connection established based on a first handshake protocol. The transport layer connection between the base station 201 and the UE 203 may be a TCP connection established based on a second handshake protocol.

During an interaction 245, the base station 201 may fetch at least a portion of the data from the content server 221. In embodiments, the portion of the data from the content server 221 may be fetched as TCP packets. The base station 201 may fetch at least a portion of the data before a physical channel between the base station 201 and the UE 203 is available. Hence, during an interaction 246, the base station 201 may store the portion of the data in a storage device of the base station 201, until a physical channel between the base station 201 and the UE 203 is available to transmit the portion of the data to the UE 203. Accordingly, the portion of the data may be fetched by the base station 201 from the content server 221 after the base station 201 receives the request for the network connection to the content server 221 and before an assignment of a physical channel between the base station 201 and the UE 203 has been assigned.

During an interaction 244, the base station 201 may assign a physical channel between the UE 203 and the base station 201, and the UE 203 may receive an assignment of a physical channel between the UE 203 and the base station 201. There may be various ways for the base station 201 to assign the physical channel between the UE 203 and the base station 201, based on parameters such as a condition of the physical channel between the base station 201 and the UE 203, or a size of the portion of the data stored in the storage device of the base station 201.

During an interaction 247, the base station 201 may transmit the portion of the data stored in the storage device of the base station 201 to the UE 203 when the physical channel is available between the base station 201 and the UE 203. The portion of the data may be fetched from the content server 221, and may be transmitted to the UE 203 over the physical channel between the base station 201 and the UE 203. In embodiments, the portion of the data may be transmitted to the UE 203 based on a size of the portion of the data, and a condition of the physical channel between the base station 201 and the UE 203. The base station 201 may transmit the portion of the data to the UE 203 based on a data transport control algorithm associated with a sliding window, where a size of the sliding window may be determined based on the condition of the physical channel between the base station 201 and the UE 203. Furthermore, the portion of the data may be transmitted to the UE 203 without TCP traffic control. Accordingly, the UE 203 may receive the portion of the data from the base station 201, which have been fetched from the content server 221.

During an interaction 248, the base station 201 may terminate the transport layer connection between the base station 201 and the content server 221 when data related to the request for the network connection from the UE 203 to the content server 221 has been completely transmitted to the base station 201. Similarly, during an interaction 249, the base station 201 may terminate the transport layer connection between the UE 203 and the base station 201 when data related to the request for the network connection from the UE 203 to the content server 221 has been completely transmitted to the UE 203.

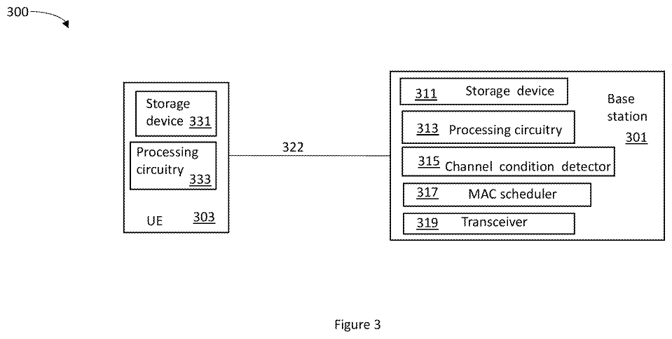

FIG. 3 illustrates an example diagram 300 for a base station 301 to transmit a portion of data to a UE 303 when a physical channel 322 is available between the base station 301 and the UE 303, in accordance with various embodiments. In embodiments, the UE 303, the base station 301, and the physical channel 322 may be examples of the UE 103, the base station 101, and the physical channel 122 as shown in FIG. 1. In embodiments, the UE 303 and the base station 301 may be examples of the UE 203 and the base station 201 as shown in FIG. 2. The UE 303 and the base station 301 may perform functions for the UE 203 and the base station 201 illustrated in FIG. 2 as described above.

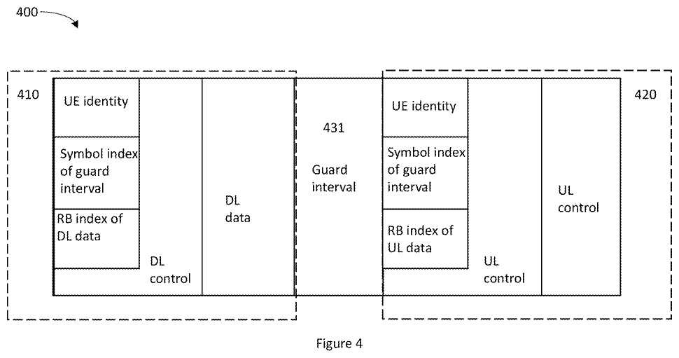

In embodiments, the base station 301 may include a storage device 311, processing circuitry 313, a channel condition detector 315, a medium-access control (MAC) scheduler 317, a transceiver 319, and other components, coupled to each other. The UE 303 may include a storage device 331, processing circuitry 333, and other components. The physical channel 322 may include a transmission time interval (TTI), with more details shown in FIG. 4.

In embodiments, the MAC scheduler 317 may be coupled to the processing circuitry 313 and the storage device 311, where the MAC scheduler 317 may schedule a TTI to transmit the portion of the data stored in the storage device 311 to the UE 303. In embodiments, the portion of the data stored in the storage device 311 may be transmitted to the UE 303 based on a size of the portion of the data stored in the storage device 311, and a condition of the physical channel 322 between the base station 301 and the UE 303. The condition of the physical channel 322 may be detected by the channel condition detector 315.

In embodiments, the storage device 311 may be distributed across multiple devices coupled together, wherein the multiple devices include one or more storage devices, one or more processors, or one or more network devices. In some other embodiments, the storage device 311 may be a single storage device attached to the base station 301.

The processing circuitry 313 may notify the MAC scheduler 317 to schedule the portion of the data to be transmitted to the UE 303 by referring to a size of the data in the storage device 311. In embodiments, the MAC scheduler 317 may schedule the TTI to transmit the portion of the data stored in the storage device 311 to the UE 303 when a size of the portion of the data stored in the storage device 311 to the UE 303 is larger than a size of data in the storage device to be transmitted to another UE. The portion of the data stored in the storage device 311 may be transmitted to the UE 303 through the transceiver 319.

The processing circuitry 313 may transmit the portion of the data stored in the storage device 311 to the UE 303 based on a data transport control algorithm associated with a sliding window. A size of the sliding window may be determined based on the condition of the physical channel 322 between the base station 301 and the UE 303. The condition of the physical channel 322 may be indicated by a link level indicator, which may be used to determine a maximum amount of data to be sent in the current scheduling slot. An arrival of a handshake signal from the UE 303 signaling the establishment of a transport layer connection between base station 301 and the UE 303 may trigger the processing circuitry 313 to move forward the sliding window. Only the data with an index in the sliding window may be allowed to be sent to the UE 303.

FIG. 4 illustrates an example diagram of a frame structure 400 for a TTI to transmit a portion of data to a UE, in accordance with various embodiments. In embodiments, the frame structure 400 may be used for a TTI to transmit data over the physical channel 322 between the UE 303 and the base station 301 as shown in FIG. 3.

In embodiments, the frame structure 400 for a TTI may include a first group of resource blocks 410 for downlink transmission to the UE, a second group of resource blocks 420 for uplink transmission from the UE, and a guard interval 431 to separate the first group of resource blocks 410 and the second group of resource blocks 420. The guard interval 431 may include a DL/UL switching index to signal a switch of the DL/UL transmission. The first group of resource blocks 410 may include an UE identify, a symbol index for the guard interval 431, and a resource block (RB) index of DL data. The first group of resource blocks 410 may further include DL control and DL data. Similarly, the second group of resource blocks 420 may include the UE identify, the symbol index for the guard interval 431, and a RB index of UL data. The second group of resource blocks 420 may further include UL control and UL data. There may be multiple occurrences of the first group of resource blocks for downlink transmission to the UE, and the second group of resource blocks for uplink transmission within a TTI, separated by the guard interval 431. In embodiments, the separation of the first group of resource blocks for downlink transmission to the UE and the second group of resource blocks for uplink transmission within a TTI may be disabled.

In embodiments, the DL transport may be conducted at the start of a TTI for the data delivery. The DL/UL switching index may indicate the index of the resource block where the guard interval 431 may be initiated. By referring to the index of the RB within the guard interval 431, a UE, e.g., the UE 303, may be able to send the data over the UL after the guard interval 431 ends. Similarly, a UE, e.g., the UE 303, may indicate the symbol index for a guard interval of a next TTI. With the symbol index for a guard interval of the next TTI, a base station, e.g., the base station 301, may determine the instance for initiation of the next DL transport.

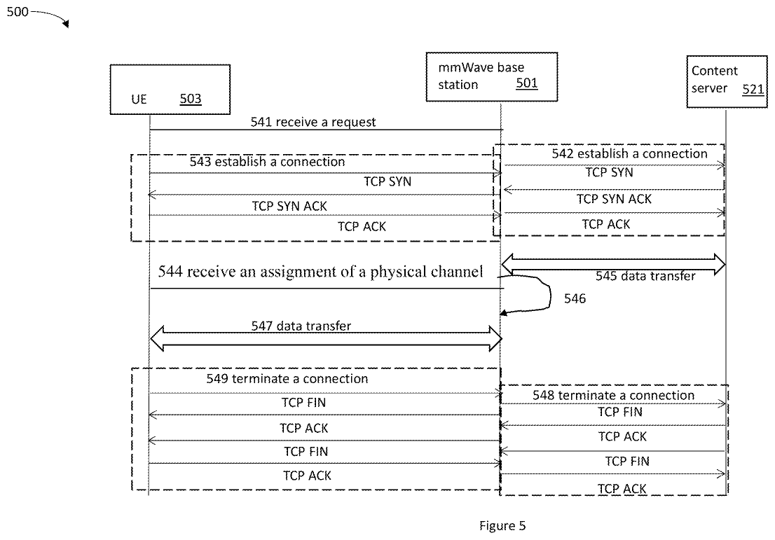

FIG. 5 illustrates an example process 500 for a UE 503, a mmWave base station 501, and a content server 521, in a mmWave cellular network to establish a transport layer connection between the nWave base station 501 and the content server 521 based on a request for a transport layer connection between the UE 503 and the content server 521, in accordance with various embodiments. In embodiments, the UE 503, the mmWave base station 501, and the content server 521 may be examples of the UE 103, the base station 101, and the content server 121 as shown in FIG. 1. Furthermore, the UE 503, the mmWave base station 501, and the content server 521 may be examples of the UE 203, the base station 201, and the content server 221 shown in FIG. 2. In embodiments, the mmWave base station 501 may include a storage device to store data received from the content server 521, and processing circuitry to perform operations illustrated in the process 500. Similarly, the UE 503 may include a storage device to store data received from the content server 521, and processing circuitry to perform operations illustrated in the process 500.

In embodiments, the process 500 may start at an interaction 541. During the interaction 541, the UE 503 may transmit to the mmWave base station 501, a request for a network connection to the content server 521, where the request for the network connection may include a request for a transport layer connection between the UE 503 and the content server 521. Accordingly, the mmWave base station 501 may receive from the UE 503 the request for the network connection to the content server 521.

During an interaction 542, the mmWave base station 501 may establish a TCP connection between the mmWave base station 501 and the content server 521 based on the request for the transport layer connection between the UE 503 and the content server 521.

During an interaction 543, the mmWave base station 501 may establish a TCP connection between the UE 503 and the mmWave base station 501. In embodiments, the TCP connection between the mmWave base station 501 and the content server 521 may be a TCP connection established based on a first handshake protocol. The TCP connection between the mmWave base station 501 and the UE 503 may be established based on a second handshake protocol. In detail, the first handshake protocol for establishing the TCP connection between the mmWave base station 501 and the content server 521 may include a TCP SYN, a TCP SYN ACK, and a TCP ACK. Similarly, the second handshake protocol for establishing the TCP connection between the nmWave base station 501 and the UE 503 may include a TCP SYN, a TCP SYN ACK, and a TCP ACK.

During an interaction 545, the mmWave base station 501 may fetch at least a portion of the data from the content server 521. During an interaction 546, the mmWave base station 501 may store the portion of the data in a storage device of the nmWave base station 501, until a physical channel between the mmWave base station 501 and the UE 503 is available to transmit the portion of the data to the UE 503. During an interaction 544, the mmWave base station 501 may assign a physical channel between the UE 503 and the mmWave base station 501, and the UE 503 may receive an assigmnent of a physical channel between the UE 503 and the mmWave base station 501. During an interaction 547, the mmWave base station 501 may transmit the portion of the data stored in the storage device of the mmWave base station 501 to the UE 503 when the physical channel is available between the nmWave base station 501 and the UE 503. The mmWave base station 501 may transmit the portion of the data to the UE 503 based on a data transport control algorithm associated with a sliding window, where a size of the sliding window may be determined based on the condition of the physical channel between the mmWave base station 501 and the UE 503.

Furthermore, the portion of the data may be transmitted to the UE 503 without TCP traffic control.

During an interaction 548, the mmWave base station 501 may terminate the transport layer connection between the mmWave base station 501 and the content server 521 when data related to the request for the network connection from the UE 503 to the content server 521 has been completely transmitted to the mmWave base station 501. Similarly, during an interaction 549, the mmWave base station 501 may terminate the transport layer connection between the UE 503 and the inmWave base station 501 when data related to the request for the network connection from the UE 503 to the content server 521 has been completely transmitted to the UE 503. In detail, the interaction 548 to terminate the transport layer connection between the inmWave base station 501 and the content server 521 may include a TCP FIN, a TCP ACK, a TCP FIN, and a TCP ACK. Similarly, the interaction 549 to terminate the transport layer connection between the mmWave base station 501 and the UE 503 may include a TCP FIN, a TCP ACK, a TCP FIN, and a TCP ACK.

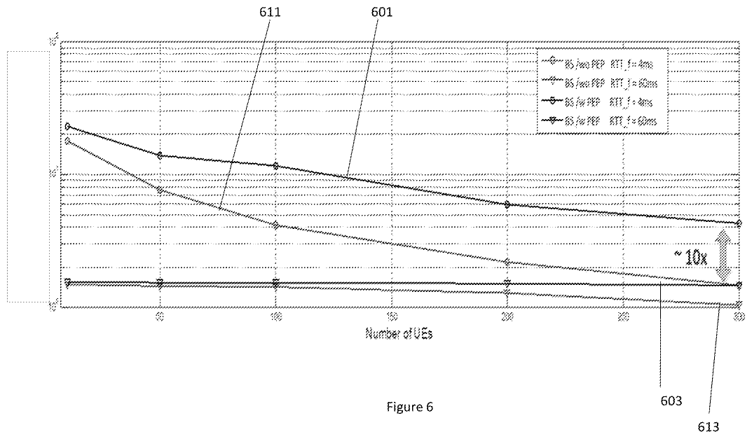

FIG. 6 illustrates a performance evaluation, in accordance with various embodiments. The performance evaluation may illustrate demonstrative performance for the base station 101, the base station 201, the base station 301, or the mmWave base station 501.

In embodiments, a performance curve 601, a performance curve 603, a performance curve 611, or a performance curve 613, illustrates an average goodput per UE (Mbps) with respect to a number of UEs in a cell served by a base station. The performance curve 601 and the performance curve 611 may be measured for a round trip time (RTT_f) equal to 4 ms between the base station and a content server in a wired network. The performance curve 603 and the performance curve 613 may be measured for a RTT_f equal to 60 ms between the base station and a content server in a wired network. The performance curve 601 and the performance curve 603 illustrate the performance for a base station performing operations illustrated in FIGS. 1-5. On the other hand, the performance curve 611 and the performance curve 613 illustrate the performance for a base station performing a normal or traditional TCP connection between a UE and the content server. It is observed that the throughput gain over the normal or traditional TCP connection between a UE and the content server may be approximately 10 times given the dense scenario wherein the amount of UEs is 300. It is disclosed that the mmWave base station without the PEP is unable to serve the UEs in the efficient way. However, the mmWave with the PEP enables the much more efficient utilization of the high data rate offered by the mmWave air interface.

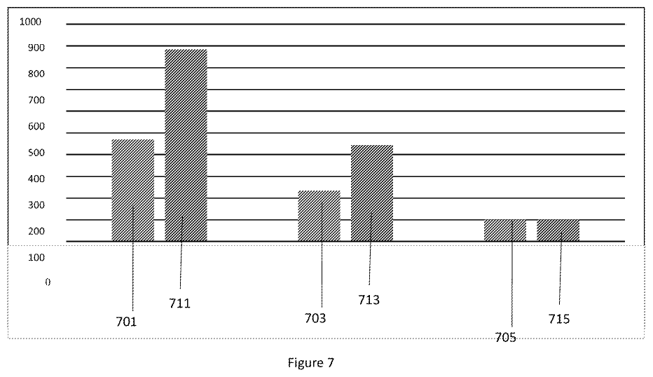

FIG. 7 illustrates a performance evaluation, in accordance with various embodiments. The performance evaluation may illustrate demonstrative performance for the base station 101, the base station 201, the base station 301, or the mmWave base station 501.

In embodiments, a bar 701, a bar 711, a bar 703, a bar 713, a bar 705, and a bar 715, may indicate an average end-to-end latency, in microsecond (ms), between a UE and a content server through a base station, including the TCP session setup and the TCP data transport given the various applications, e.g., HTTP and FTP applications. The bar 701, the bar 703, and the bar 705 may illustrate the average end-to-end latency going through a base station where operations illustrated in FIGS. 2-5 may be implemented, while the bar 711, the bar 713, and the bar 715 may illustrate the average end-to-end latency going through a base station without implementing the operations illustrated in FIGS. 2-5. The bar 701 and the bar 711 may be for a base station with 4 RF chains, the bar 703 and the bar 713 may be for a base station with 8 RF chains, and the bar 705 and the bar 715 may be for a base station with 1 RF chain. As illustrated, in certain cases, the average end-to-end latency between a UE and a content server through a base station with operations illustrated in FIGS. 2-5 implemented may be half of the average end-to-end latency between a UE and a content server through a base station without implementing such operations. In embodiments, there may be more significant latency reduction in the presence of the applications with more handshaking exchanges such as FTP. Although there is less gain given the base station with better capabilities in serving multiple terminals (i.e. a base station with 8 RF chains), the utilization of more streams in the base station with more RF chains may lead to higher cost. Embodiments herein may enable the latency reduction with much cheaper and simpler base stations.

Traditionally, the mmWave base station may merely serve a limited number of users in each transmission slot due to the constraint spatial multiplexing capability resulting from the complexity in channel estimation and signal processing with the analog-digital conversion (ADC) and the baseband, the high data rate provisioned by the mmWave base station can only be used by small number of users. Since the close-loop control on the data transport in TCP limits the data rate injected by a single user, the total utilization of mmWave channel may be relatively low even in the presence of multiple users.

In addition, the data transport in the TCP with mmWave system may have additional insufficient usage of the radio channel due to the fact that the small-size control message has to occupy the entire TTI. For example, the TTI with the time length of 0.1 ms and the data rate of 10 Gbps may provision the transport block of 1 Mbits, while the control message in TCP is generally with the size no more than 500 bits. Thereafter, more than 95% radio resource is not used in the TTI. It may cause the significantly poor utilization of the radio channel especially given the short-lived TCP session in which the payload is with the relatively small size such as 300 Kbytes.

Furthermore, the mmWave cellular systems are likely to have very high peak rate that however is also highly variable as a result of the highly variant received RF power due to the scattering from nearby building and terrain surfaces. Such significant variation may lead to the underutilization of the radio channel caused by the slow start mechanisms in the TCP especially in the presence of the short-lived TCP connections. In addition, the large drops in rate result in the dramatically increased latency which causes the channel underutilization as well due to the inessential retransmission timeout activation.

In some situations, the split connection approaches having an intermediary may be introduced between TCP sender and TCP receiver to mitigate negative impact of the radio link. The General Packet Radio Service (GPRS) Web solution may be an example in the split connection approaches where a link-aware middleware is introduced in the mobile device, and communicates with a “server proxy” located at the other end of the wireless link, close to the wired-wireless border. TCP snoop may be another example that implements modification to the base station node of the wireless network through the deployment of a “snoop agent,” while a TCP endpoint in the mobile terminal may not be aware of the agent. The GPRSWeb solution introduces the dual-proxy architecture wherein the mobile terminal has to be updated. Although the TCP snoop eases the deployment by simply requiring the update in the base station, it may be confronted with the poor channel utilization due to the problems at TCP connection establishment and slow start algorithm. In detail, the TCP snoop may be unable to accelerate the handshaking procedure in the TCP connection establishment since it is not involved in the messages exchange between the TCP sender and the TCP receiver. Given the short-lived TCP session, a poor channel utilization may be encountered because relatively large portion of time may be spent in the TCP connection establishment. In addition, the slow start algorithm may lead to the progressive data injection from the TCP sender. The mmWave radio channel thereby may not be fully utilized by the TCP snoop agent due to the time consumed for the relatively small size of the data cached in the base station at the initial transmission round. On the other hand, the excellent directivity in the mmWave radio signal may increase the reliability in the data transport to the mobile terminal. Thus, the gain in the TCP snoop may be reduced due to the less link error encountered by the mobile terminal.

Embodiments herein may improve over the GPRSWeb solution, the TCP snoop, or other similar current techniques, and may deliver improved performance as shown in FIG. 7. Embodiments herein may be applicable to mmWare cellular systems, but are not limited to mmWare cellular systems. They may be applicable to any mobile communication network or wireless system.

FIG. 8 illustrates an example architecture of a mobile communication network that includes multiple UEs, and one or more base stations, in accordance with various embodiments. The system 800 is shown to include a user equipment (UE) 801 and a UE 802. The UEs 801 and 802 are illustrated as smartphones (e.g., handheld touchscreen mobile computing devices connectable to one or more cellular networks), but may also comprise any mobile or non-mobile computing device, such as Personal Data Assistants (PDAs), pagers, laptop computers, desktop computers, wireless handsets, or any computing device including a wireless communications interface.

In some embodiments, any of the UEs 801 and 802 can comprise an Internet of Things (IoT) UE, which can comprise a network access layer designed for low-power IoT applications utilizing short-lived UE connections. An IoT UE can utilize technologies such as machine-to-machine (M2M) or machine-type communications (MTC) for exchanging data with an MTC server or device via a public land mobile network (PLMN), Proximity-Based Service (ProSe) or device-to-device (D2D) communication, sensor networks, or IoT networks. The M2M or MTC exchange of data may be a machine-initiated exchange of data. An IoT network describes interconnecting IoT UEs, which may include uniquely identifiable embedded computing devices (within the Internet infrastructure), with short-lived connections. The IoT UEs may execute background applications (e.g., keep-alive messages, status updates, etc.) to facilitate the connections of the IoT network.

The UEs 801 and 802 may be configured to connect, e.g., communicatively couple, with a radio access network (RAN), e.g., an Evolved Universal Mobile Telecommunications System (UMTS) Terrestrial Radio Access Network (E-UTRAN) 810. The UEs 801 and 802 utilize connections 803 and 804, respectively, each of which comprises a physical communications interface or layer (discussed in further detail below); in this example, the connections 803 and 804 are illustrated as an air interface to enable communicative coupling, and can be consistent with cellular communications protocols, such as a Global System for Mobile Communications (GSM) protocol, a code-division multiple access (CDMA) network protocol, a Push-to-Talk (PTT) protocol, a PTT over Cellular (POC) protocol, a Universal Mobile Telecommunications System (UMTS) protocol, a 3GPP Long Term Evolution (LTE) protocol, a fifth generation (5G) protocol, a New Radio (NR) protocol, and the like.

In this embodiment, the UEs 801 and 802 may further directly exchange communication data via a ProSe interface 805. The ProSe interface 805 may alternatively be referred to as a sidelink interface comprising one or more logical channels, including but not limited to a Physical Sidelink Control Channel (PSCCH), a Physical Sidelink Shared Channel (PSSCH), a Physical Sidelink Discovery Channel (PSDCH), and a Physical Sidelink Broadcast Channel (PSBCH).

The UE 802 is shown to be configured to access an access point (AP) 806 via connection 807. The connection 807 can comprise a local wireless connection, such as a connection consistent with any IEEE 802.11 protocol, wherein the AP 806 would comprise a wireless fidelity (WiFiW) router. In this example, the AP 806 is shown to be connected to the Internet without connecting to the core network of the wireless system (described in further detail below).

The E-UTRAN 810 can include one or more access nodes that enable the connections 803 and 804. These access nodes (ANs) can be referred to as base stations (BSs), NodeBs, evolved NodeBs (eNBs), next Generation NodeBs (gNB), RAN nodes, and so forth, and can comprise ground stations (e.g., terrestrial access points) or satellite stations providing coverage within a geographic area (e.g., a cell). The E-UTRAN 810 may include one or more RAN nodes for providing macrocells, e.g., macro RAN node 811, and one or more RAN nodes for providing femtocells or picocells (e.g., cells having smaller coverage areas, smaller user capacity, or higher bandwidth compared to macrocells), e.g., low power (LP) RAN node 812.

Any of the RAN nodes 811 and 812 can terminate the air interface protocol and can be the first point of contact for the UEs 801 and 802. In some embodiments, any of the RAN nodes 811 and 812 can fulfill various logical functions for the E-UTRAN 810 including, but not limited to, radio network controller (RNC) functions such as radio bearer management, uplink and downlink dynamic radio resource management and data packet scheduling, and mobility management.

In accordance with some embodiments, the UEs 801 and 802 can be configured to communicate using Orthogonal Frequency-Division Multiplexing (OFDM) communication signals with each other or with any of the RAN nodes 811 and 812 over a multicarrier communication channel in accordance various communication techniques, such as, but not limited to, an Orthogonal Frequency-Division Multiple Access (OFDMA) communication technique (e.g., for downlink communications) or a Single Carrier Frequency Division Multiple Access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, a downlink resource grid can be used for downlink transmissions from any of the RAN nodes 811 and 812 to the UEs 801 and 802, while uplink transmissions can utilize similar techniques. The grid can be a time-frequency grid, called a resource grid or time-frequency resource grid, which is the physical resource in the downlink in each slot. Such a time-frequency plane representation is a common practice for OFDM systems, which makes it intuitive for radio resource allocation. Each column and each row of the resource grid corresponds to one OFDM symbol and one OFDM subcarrier, respectively. The duration of the resource grid in the time domain corresponds to one slot in a radio frame. The smallest time-frequency unit in a resource grid is denoted as a resource element. Each resource grid comprises a number of resource blocks, which describe the mapping of certain physical channels to resource elements. Each resource block comprises a collection of resource elements; in the frequency domain, this may represent the smallest quantity of resources that currently can be allocated. There are several different physical downlink channels that are conveyed using such resource blocks.

The physical downlink shared channel (PDSCH) may carry user data and higher-layer signaling to the UEs 801 and 802. The physical downlink control channel (PDCCH) may carry information about the transport format and resource allocations related to the PDSCH channel, among other things. It may also inform the UEs 801 and 802 about the transport format, resource allocation, and H-ARQ (Hybrid Automatic Repeat Request) information related to the uplink shared channel. Typically, downlink scheduling (assigning control and shared channel resource blocks to the UE 102 within a cell) may be performed at any of the RAN nodes 811 and 812 based on channel quality information fed back from any of the UEs 801 and 802. The downlink resource assignment information may be sent on the PDCCH used for (e.g., assigned to) each of the UEs 801 and 802.

The PDCCH may use control channel elements (CCEs) to convey the control information. Before being mapped to resource elements, the PDCCH complex-valued symbols may first be organized into quadruplets, which may then be permuted using a sub-block interleaver for rate matching. Each PDCCH may be transmitted using one or more of these CCEs, where each CCE may correspond to nine sets of four physical resource elements known as resource element groups (REGs). Four Quadrature Phase Shift Keying (QPSK) symbols may be mapped to each REG. The PDCCH can be transmitted using one or more CCEs, depending on the size of the downlink control information (DCI) and the channel condition. There can be four or more different PDCCH formats defined in LTE with different numbers of CCEs (e.g., aggregation level, L=1, 2, 4, or 8).

Some embodiments may use concepts for resource allocation for control channel information that are an extension of the above-described concepts. For example, some embodiments may utilize an enhanced physical downlink control channel (EPDCCH) that uses PDSCH resources for control information transmission. The EPDCCH may be transmitted using one or more enhanced the control channel elements (ECCEs). Similar to above, each ECCE may correspond to nine sets of four physical resource elements known as an enhanced resource element groups (EREGs). An ECCE may have other numbers of EREGs in some situations.

The RAN nodes 811 and 812 may communicate with one another and/or with other access nodes in the E-UTRAN 810 and/or in another RAN via an X2 interface, which is a signaling interface for communicating data packets between ANs. Some other suitable interface for communicating data packets directly between ANs may be used.

The E-UTRAN 810 is shown to be communicatively coupled to a core network in this embodiment, an Evolved Packet Core (EPC) network 820 via an S1 interface 813. In this embodiment the S1 interface 813 is split into two parts: the S1-U interface 814, which carries traffic data between the RAN nodes 811 and 812 and the serving gateway (S-GW) 822, and the S1-mobility management entity (MME) interface 815, which is a signaling interface between the RAN nodes 811 and 812 and MMEs 821.

In this embodiment, the EPC network 820 comprises the MMEs 821, the S-GW 822, the Packet Data Network (PDN) Gateway (P-GW) 823, and a home subscriber server (HSS) 824. The MMEs 821 may be similar in function to the control plane of legacy Serving General Packet Radio Service (GPRS) Support Nodes (SGSN). The MMEs 821 may manage mobility aspects in access such as gateway selection and tracking area list management. The HSS 824 may comprise a database for network users, including subscription-related information to support the network entities' handling of communication sessions. The EPC network 820 may comprise one or several HSSs 824, depending on the number of mobile subscribers, on the capacity of the equipment, on the organization of the network, etc. For example, the HSS 824 can provide support for routing/roaming, authentication, authorization, naming/addressing resolution, location dependencies, etc.

The S-GW 822 may terminate the S1 interface 813 towards the E-UTRAN 810, and routes data packets between the E-UTRAN 810 and the EPC network 820. In addition, the S-GW 822 may be a local mobility anchor point for inter-RAN node handovers and also may provide an anchor for inter-3GPP mobility. Other responsibilities may include lawful intercept, charging, and some policy enforcement.

The P-GW 823 may terminate an SGi interface toward a PDN. The P-GW 823 may route data packets between the EPC network 823 and external networks such as a network including the application server 830 (alternatively referred to as application function (AF)) via an Internet Protocol (IP) interface 825. Generally, the application server 830 may be an element offering applications that use IP bearer resources with the core network (e.g., UMTS Packet Services (PS) domain, LTE PS data services, etc.). In this embodiment, the P-GW 823 is shown to be communicatively coupled to an application server 830 via an IP communications interface 825. The application server 830 can also be configured to support one or more communication services (e.g., Voice-over-Internet Protocol (VoIP) sessions, PTT sessions, group communication sessions, social networking services, etc.) for the UEs 801 and 802 via the EPC network 820.

The P-GW 823 may further be a node for policy enforcement and charging data collection. Policy and Charging Enforcement Function (PCRF) 826 is the policy and charging control element of the EPC network 820. In a non-roaming scenario, there may be a single PCRF in the Home Public Land Mobile Network (HPLMN) associated with a UE's Internet Protocol Connectivity Access Network (IP-CAN) session. In a roaming scenario with local breakout of traffic, there may be two PCRFs associated with a UE's IP-CAN session: a Home PCRF (H-PCRF) within a HPLMN and a Visited PCRF (V-PCRF) within a Visited Public Land Mobile Network (VPLMN). The PCRF 826 may be communicatively coupled to the application server 830 via the P-GW 823. The application server 830 may signal the PCRF 826 to indicate a new service flow and select the appropriate Quality of Service (QoS) and charging parameters. The PCRF 826 may provision this rule into a Policy and Charging Enforcement Function (PCEF) (not shown) with the appropriate traffic flow template (TFT) and QoS class of identifier (QCI), which commences the QoS and charging as specified by the application server 830.

FIG. 9 illustrates a block diagram of an implementation for a base station and/or UEs, in accordance with various embodiments. In some embodiments, the device 900 may include application circuitry 902, baseband circuitry 904, Radio Frequency (RF) circuitry 906, front-end module (FEM) circuitry 908, one or more antennas 910, and power management circuitry (PMC) 912 coupled together at least as shown. The components of the illustrated device 900 may be included in a UE or a RAN node. In some embodiments, the device 900 may include less elements (e.g., a RAN node may not utilize application circuitry 902, and instead include a processor/controller to process IP data received from an EPC). In some embodiments, the device 900 may include additional elements such as, for example, memory/storage, display, camera, sensor, or input/output (I/O) interface. In other embodiments, the components described below may be included in more than one device (e.g., said circuitries may be separately included in more than one device for Cloud-RAN (C-RAN) implementations).

The application circuitry 902 may include one or more application processors. For example, the application circuitry 902 may include circuitry such as, but not limited to, one or more single-core or multi-core processors. The processor(s) may include any combination of general-purpose processors and dedicated processors (e.g., graphics processors, application processors, etc.). The processors may be coupled with or may include memory/storage and may be configured to execute instructions stored in the memory/storage to enable various applications or operating systems to run on the device 900. In some embodiments, processors of application circuitry 902 may process IP data packets received from an EPC.

The baseband circuitry 904 may include circuitry such as, but not limited to, one or more single-core or multi-core processors. The baseband circuitry 904 may include one or more baseband processors or control logic to process baseband signals received from a receive signal path of the RF circuitry 906 and to generate baseband signals for a transmit signal path of the RF circuitry 906. Baseband processing circuitry 904 may interface with the application circuitry 902 for generation and processing of the baseband signals and for controlling operations of the RF circuitry 906. For example, in some embodiments, the baseband circuitry 904 may include a third generation (3G) baseband processor 904A, a fourth generation (4G) baseband processor 904B, a fifth generation (5G) baseband processor 904C, or other baseband processor(s) 904D for other existing generations, generations in development or to be developed in the future (e.g., second generation (2G), sixth generation (6G), etc.). The baseband circuitry 904 (e.g., one or more of baseband processors 904A-D) may handle various radio control functions that enable communication with one or more radio networks via the RF circuitry 906. In other embodiments, some or all of the functionality of baseband processors 904A-D may be included in modules stored in the memory 904G and executed via a Central Processing Unit (CPU) 904E. The radio control functions may include, but are not limited to, signal modulation/demodulation, encoding/decoding, radio frequency shifting, etc. In some embodiments, modulation/demodulation circuitry of the baseband circuitry 904 may include Fast-Fourier Transform (FFT), precoding, or constellation mapping/demapping functionality. In some embodiments, encoding/decoding circuitry of the baseband circuitry 904 may include convolution, tail-biting convolution, turbo, Viterbi, or Low Density Parity Check (LDPC) encoder/decoder functionality. Embodiments of modulation/demodulation and encoder/decoder functionality are not limited to these examples and may include other suitable functionality in other embodiments.

In some embodiments, the baseband circuitry 904 may include one or more audio digital signal processor(s) (DSP) 904F. The audio DSP(s) 904F may be include elements for compression/decompression and echo cancellation and may include other suitable processing elements in other embodiments. Components of the baseband circuitry may be suitably combined in a single chip, a single chipset, or disposed on a same circuit board in some embodiments. In some embodiments, some or all of the constituent components of the baseband circuitry 904 and the application circuitry 902 may be implemented together such as, for example, on a system on a chip (SOC).

In some embodiments, the baseband circuitry 904 may provide for communication compatible with one or more radio technologies. For example, in some embodiments, the baseband circuitry 904 may support communication with an evolved universal terrestrial radio access network (EUTRAN) or other wireless metropolitan area networks (WMAN), a wireless local area network (WLAN), a wireless personal area network (WPAN). Embodiments in which the baseband circuitry 904 is configured to support radio communications of more than one wireless protocol may be referred to as multi-mode baseband circuitry.

RF circuitry 906 may enable communication with wireless networks using modulated electromagnetic radiation through a non-solid medium. In various embodiments, the RF circuitry 906 may include switches, filters, amplifiers, etc. to facilitate the communication with the wireless network. RF circuitry 906 may include a receive signal path which may include circuitry to down-convert RF signals received from the FEM circuitry 908 and provide baseband signals to the baseband circuitry 904. RF circuitry 906 may also include a transmit signal path which may include circuitry to up-convert baseband signals provided by the baseband circuitry 904 and provide RF output signals to the FEM circuitry 908 for transmission.

In some embodiments, the receive signal path of the RF circuitry 906 may include mixer circuitry 906a, amplifier circuitry 906b and filter circuitry 906c. In some embodiments, the transmit signal path of the RF circuitry 906 may include filter circuitry 906c and mixer circuitry 906a. RF circuitry 906 may also include synthesizer circuitry 906d for synthesizing a frequency for use by the mixer circuitry 906a of the receive signal path and the transmit signal path. In some embodiments, the mixer circuitry 906a of the receive signal path may be configured to down-convert RF signals received from the FEM circuitry 908 based on the synthesized frequency provided by synthesizer circuitry 906d. The amplifier circuitry 906b may be configured to amplify the down-converted signals and the filter circuitry 906c may be a low-pass filter (LPF) or band-pass filter (BPF) configured to remove unwanted signals from the down-converted signals to generate output baseband signals. Output baseband signals may be provided to the baseband circuitry 904 for further processing. In some embodiments, the output baseband signals may be zero-frequency baseband signals, although this is not a requirement. In some embodiments, mixer circuitry 906a of the receive signal path may comprise passive mixers, although the scope of the embodiments is not limited in this respect.

In some embodiments, the mixer circuitry 906a of the transmit signal path may be configured to up-convert input baseband signals based on the synthesized frequency provided by the synthesizer circuitry 906d to generate RF output signals for the FEM circuitry 908. The baseband signals may be provided by the baseband circuitry 904 and may be filtered by filter circuitry 906c.

In some embodiments, the mixer circuitry 906a of the receive signal path and the mixer circuitry 906a of the transmit signal path may include two or more mixers and may be arranged for quadrature downconversion and upconversion, respectively. In some embodiments, the mixer circuitry 906a of the receive signal path and the mixer circuitry 906a of the transmit signal path may include two or more mixers and may be arranged for image rejection (e.g., Hartley image rejection). In some embodiments, the mixer circuitry 906a of the receive signal path and the mixer circuitry 906a may be arranged for direct downconversion and direct upconversion, respectively. In some embodiments, the mixer circuitry 906a of the receive signal path and the mixer circuitry 906a of the transmit signal path may be configured for super-heterodyne operation.

In some embodiments, the output baseband signals and the input baseband signals may be analog baseband signals, although the scope of the embodiments is not limited in this respect. In some alternate embodiments, the output baseband signals and the input baseband signals may be digital baseband signals. In these alternate embodiments, the RF circuitry 906 may include analog-to-digital converter (ADC) and digital-to-analog converter (DAC) circuitry and the baseband circuitry 904 may include a digital baseband interface to communicate with the RF circuitry 906.

In some dual-mode embodiments, a separate radio IC circuitry may be provided for processing signals for each spectrum, although the scope of the embodiments is not limited in this respect.

In some embodiments, the synthesizer circuitry 906d may be a fractional-N synthesizer or a fractional N/N+1 synthesizer, although the scope of the embodiments is not limited in this respect as other types of frequency synthesizers may be suitable. For example, synthesizer circuitry 906d may be a delta-sigma synthesizer, a frequency multiplier, or a synthesizer comprising a phase-locked loop with a frequency divider.

The synthesizer circuitry 906d may be configured to synthesize an output frequency for use by the mixer circuitry 906a of the RF circuitry 906 based on a frequency input and a divider control input. In some embodiments, the synthesizer circuitry 906d may be a fractional N/N+1 synthesizer.

In some embodiments, frequency input may be provided by a voltage controlled oscillator (VCO), although that is not a requirement. Divider control input may be provided by either the baseband circuitry 904 or the applications processor 902 depending on the desired output frequency. In some embodiments, a divider control input (e.g., N) may be determined from a look-up table based on a channel indicated by the applications processor 902.

Synthesizer circuitry 906d of the RF circuitry 906 may include a divider, a delay-locked loop (DLL), a multiplexer and a phase accumulator. In some embodiments, the divider may be a dual modulus divider (DMD) and the phase accumulator may be a digital phase accumulator (DPA). In some embodiments, the DMD may be configured to divide the input signal by either N or N+1 (e.g., based on a carry out) to provide a fractional division ratio. In some example embodiments, the DLL may include a set of cascaded, tunable, delay elements, a phase detector, a charge pump and a D-type flip-flop. In these embodiments, the delay elements may be configured to break a VCO period up into Nd equal packets of phase, where Nd is the number of delay elements in the delay line. In this way, the DLL provides negative feedback to help ensure that the total delay through the delay line is one VCO cycle.

In some embodiments, synthesizer circuitry 906d may be configured to generate a carrier frequency as the output frequency, while in other embodiments, the output frequency may be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some embodiments, the output frequency may be a LO frequency (fLO). In some embodiments, the RF circuitry 906 may include an IQ/polar converter.

FEM circuitry 908 may include a receive signal path which may include circuitry configured to operate on RF signals received from one or more antennas 910, amplify the received signals and provide the amplified versions of the received signals to the RF circuitry 906 for further processing. FEM circuitry 908 may also include a transmit signal path which may include circuitry configured to amplify signals for transmission provided by the RF circuitry 906 for transmission by one or more of the one or more antennas 910. In various embodiments, the amplification through the transmit or receive signal paths may be done solely in the RF circuitry 906, solely in the FEM 908, or in both the RF circuitry 906 and the FEM 908.

In some embodiments, the FEM circuitry 908 may include a TX/RX switch to switch between transmit mode and receive mode operation. The FEM circuitry may include a receive signal path and a transmit signal path. The receive signal path of the FEM circuitry may include an LNA to amplify received RF signals and provide the amplified received RF signals as an output (e.g., to the RF circuitry 906). The transmit signal path of the FEM circuitry 908 may include a power amplifier (PA) to amplify input RF signals (e.g., provided by RF circuitry 906), and one or more filters to generate RF signals for subsequent transmission (e.g., by one or more of the one or more antennas 910).

In some embodiments, the PMC 912 may manage power provided to the baseband circuitry 904. In particular, the PMC 912 may control power-source selection, voltage scaling, battery charging, or DC-to-DC conversion. The PMC 912 may often be included when the device 900 is capable of being powered by a battery, for example, when the device is included in a UE. The PMC 912 may increase the power conversion efficiency while providing desirable implementation size and heat dissipation characteristics.

While FIG. 9 shows the PMC 912 coupled only with the baseband circuitry 904. However, in other embodiments, the PMC 912 may be additionally or alternatively coupled with, and perform similar power management operations for, other components such as, but not limited to, application circuitry 902, RF circuitry 906, or FEM 908.

In some embodiments, the PMC 912 may control, or otherwise be part of, various power saving mechanisms of the device 900. For example, if the device 900 is in an RRC_Connected state, where it is still connected to the RAN node as it expects to receive traffic shortly, then it may enter a state known as Discontinuous Reception Mode (DRX) after a period of inactivity. During this state, the device 900 may power down for brief intervals of time and thus save power.

If there is no data traffic activity for an extended period of time, then the device 900 may transition off to an RRC_Idle state, where it disconnects from the network and does not perform operations such as channel quality feedback, handover, etc. The device 900 goes into a very low power state and it performs paging where again it periodically wakes up to listen to the network and then powers down again. The device 900 may not receive data in this state, in order to receive data, it may transition back to RRC_Connected state.

An additional power saving mode may allow a device to be unavailable to the network for periods longer than a paging interval (ranging from seconds to a few hours). During this time, the device is totally unreachable to the network and may power down completely. Any data sent during this time incurs a large delay and it is assumed the delay is acceptable.

Processors of the application circuitry 902 and processors of the baseband circuitry 904 may be used to execute elements of one or more instances of a protocol stack. For example, processors of the baseband circuitry 904, alone or in combination, may be used execute Layer 3, Layer 2, or Layer 1 functionality, while processors of the application circuitry 904 may utilize data (e.g., packet data) received from these layers and further execute Layer 4 functionality (e.g., transmission communication protocol (TCP) and user datagram protocol (UDP) layers). As referred to herein, Layer 3 may comprise a radio resource control (RRC) layer, described in further detail below. As referred to herein, Layer 2 may comprise a medium access control (MAC) layer, a radio link control (RLC) layer, and a packet data convergence protocol (PDCP) layer, described in further detail below. As referred to herein, Layer 1 may comprise a physical (PHY) layer of a UE/RAN node, described in further detail below.

FIG. 10 illustrates interfaces of baseband circuitry as a part of an implementation for gNBs and/or UEs, in accordance with various embodiments. As discussed above, the baseband circuitry 904 of FIG. 9 may comprise processors 904A-904E and a memory 904G utilized by said processors. Each of the processors 904A-904E may include a memory interface, 1004A-1004E, respectively, to send/receive data to/from the memory 904G.

The baseband circuitry 904 may further include one or more interfaces to communicatively couple to other circuitries/devices, such as a memory interface 1012 (e.g., an interface to send/receive data to/from memory external to the baseband circuitry 904), an application circuitry interface 1014 (e.g., an interface to send/receive data to/from the application circuitry 902 of FIG. 9), an RF circuitry interface 1016 (e.g., an interface to send/receive data to/from RF circuitry 906 of FIG. 9), a wireless hardware connectivity interface 1018 (e.g., an interface to send/receive data to/from Near Field Communication (NFC) components, Bluetooth® components (e.g., Bluetooth® Low Energy), Wi-Fi® components, and other communication components), and a power management interface 1020 (e.g., an interface to send/receive power or control signals to/from the PMC 912.

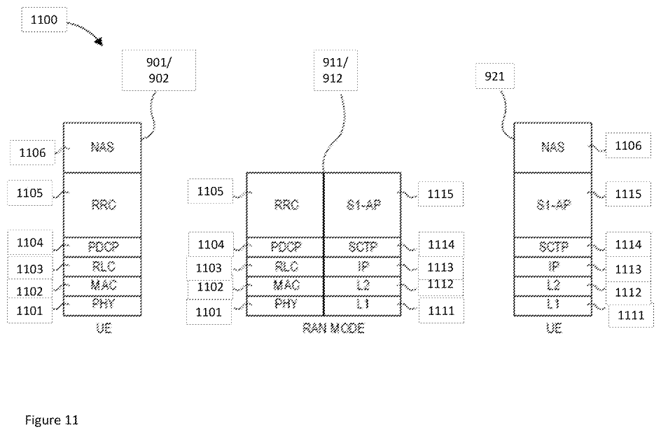

FIG. 11 illustrates an example control plane protocol stack, in accordance with various embodiments. In this embodiment, a control plane 1100 is shown as a communications protocol stack between the UE 801 (or alternatively, the UE 802), the RAN node 811 (or alternatively, the RAN node 812), and the MME 821.

The PHY layer 1101 may transmit or receive information used by the MAC layer 1102 over one or more air interfaces. The PHY layer 1101 may further perform link adaptation or adaptive modulation and coding (AMC), power control, cell search (e.g., for initial synchronization and handover purposes), and other measurements used by higher layers, such as the RRC layer 1105. The PHY layer 1101 may still further perform error detection on the transport channels, forward error correction (FEC) coding/decoding of the transport channels, modulation/demodulation of physical channels, interleaving, rate matching, mapping onto physical channels, and Multiple Input Multiple Output (MIMO) antenna processing.

The MAC layer 1102 may perform mapping between logical channels and transport channels, multiplexing of MAC service data units (SDUs) from one or more logical channels onto transport blocks (TB) to be delivered to PHY via transport channels, de-multiplexing MAC SDUs to one or more logical channels from transport blocks (TB) delivered from the PHY via transport channels, multiplexing MAC SDUs onto TBs, scheduling information reporting, error correction through hybrid automatic repeat request (HARQ), and logical channel prioritization.

The RLC layer 1103 may operate in a plurality of modes of operation, including: Transparent Mode (TM), Unacknowledged Mode (UM), and Acknowledged Mode (AM). The RLC layer 1103 may execute transfer of upper layer protocol data units (PDUs), error correction through automatic repeat request (ARQ) for AM data transfers, and concatenation, segmentation and reassembly of RLC SDUs for UM and AM data transfers. The RLC layer 1103 may also execute re-segmentation of RLC data PDUs for AM data transfers, reorder RLC data PDUs for UM and AM data transfers, detect duplicate data for UM and AM data transfers, discard RLC SDUs for UM and AM data transfers, detect protocol errors for AM data transfers, and perform RLC re-establishment.

The PDCP layer 1104 may execute header compression and decompression of IP data, maintain PDCP Sequence Numbers (SNs), perform in-sequence delivery of upper layer PDUs at re-establishment of lower layers, eliminate duplicates of lower layer SDUs at re-establishment of lower layers for radio bearers mapped on RLC AM, cipher and decipher control plane data, perform integrity protection and integrity verification of control plane data, control timer-based discard of data, and perform security operations (e.g., ciphering, deciphering, integrity protection, integrity verification, etc.).

The main services and functions of the RRC layer 1105 may include broadcast of system information (e.g., included in Master Information Blocks (MIBs) or System Information Blocks (SIBs) related to the non-access stratumn (NAS)), broadcast of system information related to the access stratum (AS), paging, establishment, maintenance and release of an RRC connection between the UE and E-UTRAN (e.g., RRC connection paging, RRC connection establishment, RRC connection modification, and RRC connection release), establishment, configuration, maintenance and release of point to point Radio Bearers, security functions including key management, inter radio access technology (RAT) mobility, and measurement configuration for UE measurement reporting. Said MIBs and SIBs may comprise one or more information elements (IEs), which may each comprise individual data fields or data structures.

The UE 801 and the RAN node 811 may utilize a Uu interface (e.g., an LTE-Uu interface) to exchange control plane data via a protocol stack comprising the PHY layer 1101, the MAC layer 1102, the RLC layer 1103, the PDCP layer 1104, and the RRC layer 1105.

The non-access stratum (NAS) protocols 1106 form the highest stratum of the control plane between the UE 801 and the MME 821. The NAS protocols 1106 support the mobility of the UE 801 and the session management procedures to establish and maintain IP connectivity between the UE 801 and the P-GW 823.

The S1 Application Protocol (S1-AP) layer 1115 may support the functions of the S1 interface and comprise Elementary Procedures (EPs). An EP is a unit of interaction between the RAN node 811 and the EPC 820. The S-AP layer services may comprise two groups: UE-associated services and non UE-associated services. These services perform functions including, but not limited to: E-UTRAN Radio Access Bearer (E-RAB) management, UE capability indication, mobility, NAS signaling transport, RAN Information Management (RIM), and configuration transfer.

The Stream Control Transmission Protocol (SCTP) layer (alternatively referred to as the SCTP/IP layer) 1114 may ensure reliable delivery of signaling messages between the RAN node 811 and the MME 821 based, in part, on the IP protocol, supported by the IP layer 1113. The L2 layer 1112 and the L1 layer 1111 may refer to communication links (e.g., wired or wireless) used by the RAN node and the MME to exchange information.

The RAN node 811 and the MME 821 may utilize an S-MME interface to exchange control plane data via a protocol stack comprising the L1 layer 1111, the L2 layer 1112, the IP layer 1113, the SCTP layer 1114, and the S1-AP layer 1115.

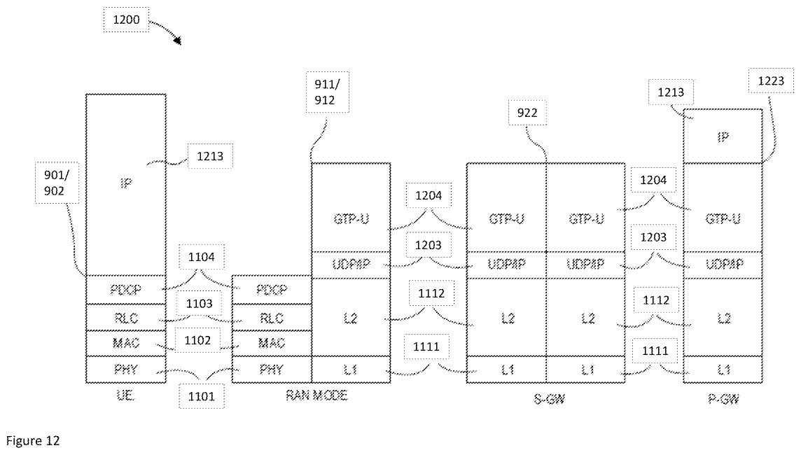

FIG. 12 illustrates an example user plane protocol stack, in accordance with various embodiments. In this embodiment, a user plane 1200 is shown as a communications protocol stack between the UE 801 (or alternatively, the UE 802), the RAN node 811 (or alternatively, the RAN node 812), the S-GW 822, and the P-GW 823. The user plane 1200 may utilize at least some of the same protocol layers as the control plane 1100. For example, the UE 801 and the RAN node 811 may utilize a Uu interface (e.g., an LTE-Uu interface) to exchange user plane data via a protocol stack comprising the PHY layer 1101, the MAC layer 1102, the RLC layer 1103, the PDCP layer 1104.

The General Packet Radio Service (GPRS) Tunneling Protocol for the user plane (GTP-U) layer 1204 may be used for carrying user data within the GPRS core network and between the radio access network and the core network. The user data transported can be packets in any of IPv4, IPv6, or PPP formats, for example. The UDP and IP security (UDP/IP) layer 1203 may provide checksums for data integrity, port numbers for addressing different functions at the source and destination, and encryption and authentication on the selected data flows. The RAN node 811 and the S-GW 822 may utilize an S1-U interface to exchange user plane data via a protocol stack comprising the L1 layer 1111, the L2 layer 1112, the UDP/IP layer 1203, and the GTP-U layer 1204. The S-GW 822 and the P-GW 823 may utilize an S5/S8a interface to exchange user plane data via a protocol stack comprising the L1 layer 1111, the L2 layer 1112, the UDP/IP layer 1203, and the GTP-U layer 1204. As discussed above with respect to FIG. 11, NAS protocols support the mobility of the UE 801 and the session management procedures to establish and maintain IP connectivity between the UE 801 and the P-GW 823.

FIG. 13 illustrates a block diagram illustrating components able to read instructions from a machine-readable or computer-readable medium and perform any one or more of the methodologies discussed herein, in accordance with various embodiments.

Specifically, FIG. 13 shows a diagrammatic representation of hardware resources 1300 including one or more processors (or processor cores) 1310, one or more memory/storage devices 1320, and one or more communication resources 1330, each of which may be communicatively coupled via a bus 1340. For embodiments where node virtualization (e.g., NFV) is utilized, a hypervisor 1302 may be executed to provide an execution environment for one or more network slices/sub-slices to utilize the hardware resources 1300

The processors 1310 (e.g., a central processing unit (CPU), a reduced instruction set computing (RISC) processor, a complex instruction set computing (CISC) processor, a graphics processing unit (GPU), a digital signal processor (DSP) such as a baseband processor, an application specific integrated circuit (ASIC), a radio-frequency integrated circuit (RFIC), another processor, or any suitable combination thereof) may include, for example, a processor 1312 and a processor 1314.

The memory/storage devices 1320 may include main memory, disk storage, or any suitable combination thereof. The memory/storage devices 1320 may include, but are not limited to any type of volatile or non-volatile memory such as dynamic random access memory (DRAM), static random-access memory (SRAM), erasable programmable read-only memory (EPROM), electrically erasable programmable read-only memory (EEPROM), Flash memory, solid-state storage, etc.

The communication resources 1330 may include interconnection or network interface components or other suitable devices to communicate with one or more peripheral devices 1304 or one or more databases 1306 via a network 1308. For example, the communication resources 1330 may include wired communication components (e.g., for coupling via a Universal Serial Bus (USB)), cellular communication components, NFC components, Bluetooth® components (e.g., Bluetooth. Low Energy), Wi-Fi® components, and other communication components.

Instructions 1350 may comprise software, a program, an application, an applet, an app, or other executable code for causing at least any of the processors 1310 to perform any one or more of the methodologies discussed herein. The instructions 1350 may reside, completely or partially, within at least one of the processors 1310 (e.g., within the processor's cache memory), the memory/storage devices 1320, or any suitable combination thereof. Furthermore, any portion of the instructions 1350 may be transferred to the hardware resources 1300 from any combination of the peripheral devices 1304 or the databases 1306. Accordingly, the memory of processors 1310, the memory/storage devices 1320, the peripheral devices 1304, and the databases 1306 are examples of computer-readable and machine-readable media.

In embodiments, one or more elements of FIGS. 8-13 may be configured to perform one or more processes, techniques, or methods as described herein, or portions thereof, e.g., processes shown in FIGS. 1-5. For example, the one or more elements of FIGS. 8-13 may be configured to perform operations such as receiving, from the UE, a request for a network connection to the content server, wherein the request for the network connection includes a request for a transport layer connection between the UE and the content server; establishing a transport layer connection between the base station and the content server based on the request for the transport layer connection between the UE and the content server; fetching at least a portion of the data from the content server and store the portion of the data in the storage device before a physical channel between the base station and the UE is available; and transmitting the portion of the data stored in the storage device to the UE when the physical channel is available between the base station and the UE. Additionally, the one or more elements of FIGS. 8-13 may be configured to perform operations such as transmitting, to the base station, a request for a network connection to the content server, wherein the request for the network connection includes a request for a transport layer connection between the UE and the content server; establishing a transport layer connection between the UE and the base station based on the request for the transport layer connection between the UE and the content server; receiving an assignment of a physical channel between the UE and the base station; and receiving at least a portion of the data from the content server transmitted over the physical channel, wherein the portion of the data are fetched by the base station from the content server after the base station receives the request for the network connection to the content server and before receiving the assignment of the physical channel, and stored in the base station after being fetched. In embodiments, one or more elements of FIGS. 8-13 may be configured to perform one or more processes, techniques, or methods, or portions thereof, as described in the following examples.

### EXAMPLES

Example 1 may include an apparatus to be used in a base station in a mobile communication network to communicate with a user equipment (UE), the apparatus comprising: a storage device to store data received from a content server; and processing circuitry, coupled with the storage device, the processing circuitry to: receive, from the UE, a request for a network connection to the content server, wherein the request for the network connection includes a request for a transport layer connection between the UE and the content server; establish a transport layer connection between the base station and the content server based on the request for the transport layer connection between the UE and the content server; fetch at least a portion of the data from the content server and store the portion of the data in the storage device before a physical channel between the base station and the UE is available; and transmit the portion of the data stored in the storage device to the UE when the physical channel is available between the base station and the UE.

Example 2 may include the apparatus of example 1 and/or some other examples herein, wherein the processing circuitry is further to: establish a transport layer connection between the UE and the base station before the processing circuitry is to transmit the portion of the data stored in the storage device to the UE, wherein the transport layer connection between the UE and the base station and the transport layer connection between the base station and the content server substitute the transport layer connection between the UE and the content server.

Example 3 may include the apparatus of example 2 and/or some other examples herein, wherein the processing circuitry is further to: terminate the transport layer connection between the base station and the content server when data related to the request for the network connection from the UE to the content server has been completely transmitted to the base station.

Example 4 may include the apparatus of example 2 and/or some other examples herein, wherein the transport layer connection between the base station and the content server is a transmission control protocol (TCP) connection established based on a first handshake protocol, and the transport layer connection between the base station and the UE is a TCP connection established based on a second handshake protocol.

Example 5 may include the apparatus of example 4 and/or some other examples herein, wherein the portion of the data from the content server are fetched as TCP packets.

Example 6 may include the apparatus of example 4 and/or some other examples herein, wherein the portion of the data stored in the storage device from the content server are transmitted to the UE without TCP traffic control.

Example 7 may include the apparatus of example 1 and/or some other examples herein, wherein the portion of the data stored in the storage device are transmitted to the UE based on a size of the portion of the data stored in the storage device, and a condition of the physical channel between the base station and the UE.

Example 8 may include the apparatus of example 7 and/or some other examples herein, wherein the processing circuitry is to transmit the portion of the data stored in the storage device to the UE based on a data transport control algorithm associated with a sliding window.

Example 9 may include the apparatus of example 8 and/or some other examples herein, wherein a size of the sliding window is determined based on the condition of the physical channel between the base station and the UE.

Example 10 may include the apparatus of example 1 and/or some other examples herein, further comprising: a medium-access control (MAC) scheduler coupled to the processing circuitry and the storage device, wherein the MAC scheduler is to schedule a transmission time interval (TTI) to transmit the portion of the data stored in the storage device to the UE.

Example 11 may include the apparatus of example 10 and/or some other examples herein, wherein the MAC scheduler is to schedule the TTI to transmit the portion of the data stored in the storage device to the UE when a size of the portion of the data stored in the storage device to the UE is larger than a size of data in the storage device to be transmitted to another UE.

Example 12 may include the apparatus of example 10 and/or some other examples herein, wherein the TTI includes a first group of resource blocks for downlink transmission to the UE, a second group of resource blocks for uplink transmission from the UE, and a guard interval to separate the first group of resource blocks and the second group of resource blocks.

Example 13 may include the apparatus of example 1 and/or some other examples herein, wherein the content server is distributed across multiple devices coupled together, wherein the multiple devices include one or more storage devices, one or more processors, or one or more network devices; and the storage device is distributed across multiple devices coupled together, wherein the multiple devices include one or more storage devices, one or more processors, or one or more network devices.

Example 14 may include an apparatus to be used in a user equipment (UE) in a mobile communication network to communicate with a base station, comprising: a storage device to store data received from a content server; and processing circuitry, coupled with the storage device, the processing circuitry to: transmit, to the base station, a request for a network connection to the content server, wherein the request for the network connection includes a request for a transport layer connection between the UE and the content server; establish a transport layer connection between the UE and the base station based on the request for the transport layer connection between the UE and the content server; receive an assignment of a physical channel between the UE and the base station; and receive at least a portion of the data from the content server transmitted over the physical channel, wherein the portion of the data are fetched by the base station from the content server after the base station receives the request for the network connection to the content server and before receiving the assignment of the physical channel, and stored in the base station after being fetched.

Example 15 may include the apparatus of example 14 and/or some other examples herein, wherein the processing circuitry is further to terminate the transport layer connection between the UE and the base station when data related to the request for the network connection from the UE to the content server has been completely transmitted to the UE.

Example 16 may include the apparatus of example 14 and/or some other examples herein, wherein the physical channel includes a transmission time interval (TTI), and the TTI includes a first group of resource blocks for downlink transmission to the UE, a second group of resource blocks for uplink transmission from the UE, and a guard interval to separate the first group of resource blocks and the second group of resource blocks.

Example 17 may include the apparatus of example 14 and/or some other examples herein, wherein the transport layer connection between the UE and the base station is a transmission control protocol (TCP) connection established based on a handshake protocol.

Example 18 may include the apparatus of example 17 and/or some other examples herein, wherein the portion of the data from the content server are received as TCP packets.

Example 19 may include the apparatus of example 14 and/or some other examples herein, wherein the portion of the data are received based on a data transport control algorithm associated with a sliding window.

Example 20 may include the apparatus of example 19 and/or some other examples herein, wherein a size of the sliding window is determined by a condition of the physical channel between the base station and the UE.

Example 21 may include an apparatus to be used in a millimeter-wave (mmWave) base station in a mmWave cellular network to communicate with a user equipment (UE), the apparatus comprising: a storage device to store data received from a content server; and processing circuitry, coupled with the storage device, the processing circuitry to: receive, from the UE, a request for a network connection to the content server, wherein the request for the network connection includes a request for a transport layer connection between the UE and the content server; establish a first transmission control protocol (TCP) connection between the UE and the mmWave base station based on the request for the transport layer connection between the UE and the content server; establish a second TCP connection between the mmWave base station and the content server based on the request for the transport layer connection, wherein the first TCP connection and the second TCP connection substitute the transport layer connection between the UE and the content server; fetch at least a portion of the data from the content server and store the portion of the data in the storage device before a physical channel between the mmWave base station and the UE is available, wherein the portion of the data are fetched as TCP packets; and transmit the portion of the data stored in the storage device to the UE when the physical channel is available between the mmWave base station and the UE.

Example 22 may include the apparatus of example 21 and/or some other examples herein, wherein the portion of the data stored in the storage device are transmitted to the UE without TCP traffic control.

Example 23 may include the apparatus of example 21 and/or some other examples herein, further comprising: a medium-access control (MAC) scheduler coupled to the processing circuitry and the storage device, wherein the MAC scheduler is to schedule a transmission time interval (TTI) to be the physical channel to transmit the portion of the data stored in the storage device to the UE.

Example 24 may include the apparatus of example 23 and/or some other examples herein, wherein the MAC scheduler is to schedule the TTI to transmit the portion of the data stored in the storage device to the UE when a size of the portion of the data stored in the storage device to the UE is larger than a size of data in the storage device to be transmitted to another UE.

Example 25 may include the apparatus of example 23 and/or some other examples herein, wherein the TTI includes a first group of resource blocks for downlink transmission to the UE, a second group of resource blocks for uplink transmission from the UE, and a guard interval to separate the first group of resource blocks and the second group of resource blocks.

The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

1. An apparatus to be used in a base station in a mobile communication network to communicate with a user equipment (UE) of the mobile communication network, the apparatus comprising:
a storage device to store data received from a content server; and
processing circuitry, coupled with the storage device, the processing circuitry to:
receive, from the UE, a request for a network connection to the content server, wherein the request for the network connection includes a request for a transport layer connection between the UE and the content server;
establish a transport layer connection between the base station and the content server based on the request for the transport layer connection between the UE and the content server;
fetch at least a portion of the data from the content server and store the portion of the data in the storage device before a physical channel between the base station and the UE is available; and
transmit the portion of the data stored in the storage device to the UE when the physical channel is available between the base station and the UE.

2. The apparatus of claim 1, wherein the processing circuitry is further to:
establish a transport layer connection between the UE and the base station before the processing circuitry is to transmit the portion of the data stored in the storage device to the UE, wherein the transport layer connection between the UE and the base station and the transport layer connection between the base station and the content server substitute the transport layer connection between the UE and the content server.

3. The apparatus of claim 2, wherein the processing circuitry is further to:
terminate the transport layer connection between the base station and the content server when data related to the request for the network connection from the UE to the content server has been completely transmitted to the base station.

4. The apparatus of claim 2, wherein the transport layer connection between the base station and the content server is a transmission control protocol (TCP) connection established based on a first handshake protocol, and the transport layer connection between the base station and the UE is a TCP connection established based on a second handshake protocol.

5. The apparatus of claim 4, wherein the portion of the data from the content server are fetched as TCP packets.

6. The apparatus of claim 4, wherein the portion of the data stored in the storage device from the content server are transmitted to the UE without TCP traffic control.

7. The apparatus of claim 1, wherein the portion of the data stored in the storage device are transmitted to the UE based on a size of the portion of the data stored in the storage device, and a condition of the physical channel between the base station and the UE.

8. The apparatus of claim 7, wherein the processing circuitry is to transmit the portion of the data stored in the storage device to the UE based on a data transport control algorithm associated with a sliding window.

9. The apparatus of claim 8, wherein a size of the sliding window is determined based on the condition of the physical channel between the base station and the UE.

10. The apparatus of claim 1, further comprising:
a medium-access control (MAC) scheduler coupled to the processing circuitry and the storage device, wherein the MAC scheduler is to schedule a transmission time interval (TTI) to transmit the portion of the data stored in the storage device to the UE.

11. The apparatus of claim 10, wherein the MAC scheduler is to schedule the TTI to transmit the portion of the data stored in the storage device to the UE when a size of the portion of the data stored in the storage device to the UE is larger than a size of data in the storage device to be transmitted to another UE.

12. The apparatus of claim 10, wherein the TTI includes a first group of resource blocks for downlink transmission to the UE, a second group of resource blocks for uplink transmission from the UE, and a guard interval to separate the first group of resource blocks and the second group of resource blocks.

13. The apparatus of claim 1, wherein the content server is distributed across multiple devices coupled together, wherein the multiple devices include one or more storage devices, one or more processors, or one or more network devices; and the storage device is distributed across multiple devices coupled together, wherein the multiple devices include one or more storage devices, one or more processors, or one or more network devices.

14. An apparatus to be used in a user equipment (UE) in a mobile communication network to communicate with a base station of the mobile communication network, comprising:
a storage device to store data received from a content server; and
processing circuitry, coupled with the storage device, the processing circuitry to:
transmit, to the base station, a request for a network connection to the content server, wherein the request for the network connection includes a request for a transport layer connection between the UE and the content server;
establish a transport layer connection between the UE and the base station based on the request for the transport layer connection between the UE and the content server;
receive an assignment of a physical channel between the UE and the base station; and
receive at least a portion of the data from the content server transmitted over the physical channel, wherein the portion of the data are fetched by the base station from the content server after the base station receives the request for the network connection to the content server and before receiving the assignment of the physical channel, and stored in the base station after being fetched.

15. The apparatus of claim 14, wherein the processing circuitry is further to terminate the transport layer connection between the UE and the base station when data related to the request for the network connection from the UE to the content server has been completely transmitted to the UE.

16. The apparatus of claim 14, wherein the physical channel includes a transmission time interval (TTI), and the TTI includes a first group of resource blocks for downlink transmission to the UE, a second group of resource blocks for uplink transmission from the UE, and a guard interval to separate the first group of resource blocks and the second group of resource blocks.

17. The apparatus of claim 14, wherein the transport layer connection between the UE and the base station is a transmission control protocol (TCP) connection established based on a handshake protocol.

18. The apparatus of claim 17, wherein the portion of the data from the content server are received as TCP packets.

19. The apparatus of claim 14, wherein the portion of the data are received based on a data transport control algorithm associated with a sliding window.

20. The apparatus of claim 19, wherein a size of the sliding window is determined by a condition of the physical channel between the base station and the UE.

21. An apparatus to be used in a millimeter-wave (mmWave) base station in a mmWave cellular network to communicate with a user equipment (UE) of the mmWave cellular network, the apparatus comprising:
a storage device to store data received from a content server; and
processing circuitry, coupled with the storage device, the processing circuitry to:
receive, from the UE, a request for a network connection to the content server, wherein the request for the network connection includes a request for a transport layer connection between the UE and the content server;
establish a first transmission control protocol (TCP) connection between the UE and the mmWave base station based on the request for the transport layer connection between the UE and the content server;
establish a second TCP connection between the mmWave base station and the content server based on the request for the transport layer connection, wherein the first TCP connection and the second TCP connection substitute the transport layer connection between the UE and the content server;
fetch at least a portion of the data from the content server and store the portion of the data in the storage device before a physical channel between the mmWave base station and the UE is available, wherein the portion of the data are fetched as TCP packets; and
transmit the portion of the data stored in the storage device to the UE when the physical channel is available between the mmWave base station and the UE.

22. The apparatus of claim 21, wherein the portion of the data stored in the storage device are transmitted to the UE without TCP traffic control.

23. The apparatus of claim 21, further comprising:
a medium-access control (MAC) scheduler coupled to the processing circuitry and the storage device, wherein the MAC scheduler is to schedule a transmission time interval (TTI) to be the physical channel to transmit the portion of the data stored in the storage device to the UE.

24. The apparatus of claim 23, wherein the MAC scheduler is to schedule the TTI to transmit the portion of the data stored in the storage device to the UE when a size of the portion of the data stored in the storage device to the UE is larger than a size of data in the storage device to be transmitted to another UE.

25. The apparatus of claim 23, wherein the TTI includes a first group of resource blocks for downlink transmission to the UE, a second group of resource blocks for uplink transmission from the UE, and a guard interval to separate the first group of resource blocks and the second group of resource blocks.
